(19) United States
(12) Patent Application Publication
(10) Pub. No.: US 2007/0285776 A1
(43) Pub. Date: Dec. 13, 2007

(54) Anti-Reflection Film

(75) Inventors: Kazuhiro Nakamura, Minami-Ashigara-shi (JP); Takumi Ando, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/659,797

(22) PCT Filed: Aug. 3, 2005
(86) PCT No.: PCT/JP05/14601

§ 371 Date: Feb. 9, 2007

(30) Foreign Application Priority Data
Aug. 12, 2004 (JP) 2004-235400

(51) Int. Cl. G02B 1/11; G02B 5/30

(52) U.S. Cl. 359/485; 359/586; 427/541

(57) ABSTRACT

An anti-reflection film having a hard coat layer attaining both improvement in resistance to unevenness in interference under an artificial light source and solution to handling problems such as curling and brittleness and sufficient anti-reflection properties, scratch resistance and productivity is provided. The anti-reflection film includes a transparent support, a hard coat layer, and a low refractive index layer having in this order. The dry thickness of the hard coat layer is from 6 to 15 μm. The color difference of light from an artificial light source reflected by the hard coat layer between at an arbitrary point and another arbitrary point disposed 5 mm apart therefrom in the film longitudinal or crosswise direction is 2.0 or less as calculated in terms of ΔEab* value of CIE.

### TECHNICAL FIELD

The present invention relates to an anti-reflection film and more particularly to an anti-reflection film having less unevenness in interference due to unevenness in thickness of hard coat layer.

### BACKGROUND ART

In order to prevent the drop of contrast due to the reflection of external light rays or the reflection of image, an anti-reflection film is normally disposed on the surface of the screen of various image displays such as cathode ray tube display (CRT), plasma display panel (PDP), electroluminescence display (ELD) and liquid crystal display (LCD) to reduce reflectance using the principle of optical interference.

Such an anti-reflection film is normally prepared by forming a film including a low refractive index layer having a lower refractive index than that of a transparent support on the transparent support to a proper thickness as an outermost layer. In order to attain a low reflectance, it is desirable that the low refractive index layer be made of a material having as low a refractive index as possible. The anti-reflection film is also required to have a high scratch resistance because it is used as an outermost surface of the display. In the case where the support is a plastic film having a thickness of from scores of micrometers to few millimeters, a hard coat layer for compensating the low indentation elasticity of the support is essential in addition to the strength of the film of the low refractive index layer itself and the adhesion thereof to the underlying layer. In particular, in recent years, anti-reflection films having a high scratch resistance have been needed in the application to television, monitors, etc. In addition to the enhancement of the strength of the outermost layer, the improvement in indentation elasticity by the provision of hard coat layer is a great assignment.

JP-B-62-21815 and Japanese Patent No. 3,035,402 disclose abrasion-resistant coating compositions mainly composed of ultraparticulate inorganic material such as silica and polyfunctional(meth)acrylate monomer. It is disclosed that these coating compositions can be used in a thickness of from about 1 to 50 μm. The incorporation of an ultraparticulate inorganic material makes it possible to exert a great effect of improving the indentation elasticity of the hard coat layer or preventing the worsening of curling in the case where a thick coat layer is formed. On the other hand, when such a hard coat layer is formed by the means disclosed in the above documents, unevenness in color due to interference (referred to as “unevenness in interference”) by reflected light on the interface of the transparent support with the hard coat layer or the interface of the hard coat layer with the overlying layer or air occurs, causing a drastic deterioration of the display to which the anti-reflection film is applied. It has been found that when observed under an artificial illumination, the display shows remarkable unevenness in interference due to hard coat layer as compared with under sunshine or tungsten lamp. In recent years, artificial illuminations have been widely spread. Therefore, displays comprising a hard coat film provided on the surface of screen are quite often used under an artificial illumination. It has thus been desired to eliminate unevenness in interference.

JP-A-2003-131007 discloses that an optical film having a continuous change of refractive index in the vicinity of the interference of hard coat layer with substrate is obtained by coating a hard coat layer coating solution comprising a solvent in which the support swells or is dissolved. However, JP-A-2003-131007 discloses that a 1:1 by weight mixture of methyl ethyl ketone and methyl acetate is used for a triacetyl cellulose substrate. Therefore, it is advantageous in that when the drying conditions vary, the resulting hard coat layer is more subject to whitening or curling.

JP-A-2003-213023 discloses a surface protective film composed of a coat layer made of two or more resins having different refractive indexes and a transparent film substrate wherein the difference in refractive index between the coat layer and the transparent film substrate is not greater than 0.013. For example, however, triacetyl cellulose, if used as a transparent substrate, has a refractive index of from 1.48 to 1.49. In order to determine the difference in refractive index between the hard coat layer and the substrate to be 0.013 or less, an acrylic resin and a fluororesin are mixed at a ratio of 7:3. Therefore, in the case where an anti-reflection layer is provided with a hard coat layer interposed between the anti-reflection layer and the support as in the invention, a problem arises that the coatability is remarkably deteriorated or the interfacial adhesion is deteriorated.

In other words, it is the actual status that no anti-reflection films including a hard coat layer attaining sufficient improvement in resistance to unevenness in interference, which is particularly remarkable under an artificial illumination, have been proposed yet.

### DISCLOSURE OF THE INVENTION

An object of a non-limiting, illustrative embodiment of the invention is to provide an anti-reflection film attaining practically sufficient improvement in resistance to unevenness in interference as well as sufficient anti-reflection properties and scratch resistance. Another object of a non-limiting, illustrative embodiment of the invention is to provide a polarizing plate and a display including the anti-reflection film.

The inventors made extensive studies of solution to the aforementioned problems. As a result, it was found that the aforementioned objects of the invention can be accomplished by properly adjusting the formulation of the transparent resin to be incorporated in the hard coat layer and the thickness of the hard coat layer. The invention has thus been worked out.

In other words, the aforementioned objects of the invention can be accomplished by the following constitutions.

1. An anti-reflection film comprising: a transparent support; a hard coat layer comprising a transparent resin; and a low refractive index layer having a lower refractive index than that of both the transparent support and the hard coat layer, in this order, wherein the hard coat layer has a thickness (dry thickness) of 5 to 15 μm, and a color difference of reflected light, with respect to incident light from an artificial light source, between at a first point on the hard coat layer and at a second point disposed 5 mm apart from the first point in a longitudinal or crosswise direction of the anti-reflection film is 2.0 or less as calculated in terms of ΔEab* value of CIE.

2. An anti-reflection film comprising: a transparent support; a hard coat layer comprising a transparent resin; and a low refractive index layer having a lower refractive index than that of both the transparent support and the hard coat layer, in this order, wherein the hard coat layer has a thickness (dry thickness) of 5 to 15 μm, and a color difference of reflected light, with respect to incident light from an artificial light source, between at a first point on the hard coat layer and at a second point disposed 10 mm apart from the first point in a longitudinal or crosswise direction of the anti-reflection film is 2.0 or less as calculated in terms of ΔEab* value of CIE.

3. An anti-reflection film comprising: a transparent support; a hard coat layer comprising a transparent resin; and a low refractive index layer having a lower refractive index than that of both the transparent support and the hard coat layer, in this order, wherein the hard coat layer has a thickness (dry thickness) of 5 to 15 μm, and a color difference of reflected light, with respect to incident light from an artificial light source, between at a first point on the hard coat layer and at a second point disposed 30 mm apart from the first point in a longitudinal or crosswise direction of the anti-reflection film is 2.0 or less as calculated in terms of ΔEab* value of CIE.

4. The anti-reflection film as defined in any one of Clauses 1 to 3, wherein the thickness of the hard coat layer is from 6 to 15 μm.

5. The anti-reflection film as defined in any one of Clauses 1 to 4, which has a ratio nh/nb of a refractive index nh of the hard coat layer to a refractive index nb of the transparent support of from 0.97 to 1.05.

6. The anti-reflection film as defined in any one of Clauses 1 to 5, wherein the thickness of the hard coat layer falls within a range in which an amplitude of a waveform of a graph obtained by the following steps (a) to (e) is minimum:

(a) Step of measuring a specular reflection spectrum of the hard coat layer at an incidence angle of 5° in a wavelength range of from 380 nm to 780 nm;

(b) Step of calculating a color of reflected light with respect to the specular reflection spectrum measured at the step (a) as an L, a* and b* values of CIE using CIE F-12 light source as emission spectrum of artificial illumination;

(c) Step of repeating the step (b) every 0.02 μm over the thickness range of the hard coat layer of from 5 μm to 10 μm;

(d) Step of calculating, as the average color, an average L, a* and b* values of CIE over the thickness range of the hard coat layer of from 5 μm to 10 μm based on results of the step (C), and determining a color change ΔEab* value from the average color at various thicknesses of from 5 μm to 10 μm; and

(e) Step of graphically illustrating the thickness and the ΔEab* value plotted as abscissa and ordinate, respectively, from results of the step (d).

7. The anti-reflection film as defined in any one of Clauses 1 to 6, wherein the hard coat layer is a layer formed by coating a coating solution comprising: the transparent resin; and a solvent having a boiling point of 100° C. or less, and drying the coating solution.

8. The anti-reflection film as defined in Clause 7, wherein the drying of the coating solution is performed with drying air at a wind velocity of 1 m/sec or more.

9. The anti-reflection film as define in any one of Clauses 1 to 8, wherein the transparent support is a cellulose acylate film having a thickness of from 40 μm to 120 μm.

10. The anti-reflection film as defined in any one of Clauses 1 to 9, wherein the low refractive index layer is a cured layer formed by coating and curing a curable composition comprising mainly a fluorine-containing polymer containing: fluorine atoms in an amount of from 35 to 80% by weight; a fluorine-containing vinyl monomer polymerizing unit, and a polymerizing unit having a (meth)acryloyl group in a side chain thereof, the copolymer having a main chain of only carbon atoms, and the low refractive index layer has a refractive index of from 1.30 to 1.55.

11. The anti-reflection film as defined in Clause 10, wherein the low refractive index layer is a cured layer formed by coating and curing a curable composition comprising: (A) the fluorine-containing polymer, (B) a particulate inorganic material having an average particle diameter of from 30% to 150% of a thickness of the low refractive index layer and a hollow structure having a refractive index of from 1.17 to 1.40: and (C) at least one of a hydrolyzate and a partial condensate of an organosilane represented by formula (3), the organosilane being produced in the presence of an acid catalyst:
(R¹)ₘ—Si(X)₄₋ₘ (3)
wherein R¹ represents a substituted or unsubstituted alkyl or aryl group; X represents a hydroxyl group or hydrolyzable group; and m represents an integer of from 1 to 3.
12. The anti-reflection film as defined in any one of Clauses 1 to 9, wherein the low refractive index layer is a cured layer formed by coating and curing a curable composition comprising at least one of a hydrolyzate of a compound represented by formula (2) and a dehydration condensate thereof:
(R²)ₙ—Si(Y)₄₋ₙ (2)
wherein R² represents a substituted or unsubstituted alkyl group, partly or fully fluorine-substituted alkyl group or substituted or unsubstituted aryl group; Y represents a hydroxyl group or hydrolyzable group; and n represents an integer of from 0 to 3, and the low refractive index layer has a refractive index of from 1.30 to 1.55.
13. The anti-reflection film as defined in any one of Clauses 1 to 12, which further comprises: a middle refractive index layer having a higher refractive index than that of the hard coat layer; and a high refractive index layer having a higher refractive index than that of the middle refractive index layer in this order, and the middle and high refractive index layers is between the hard coat layer and the low refractive index layer.
14. The anti-reflection film as defined in any one of Clauses 1 to 13, wherein the low refractive index layer is an uppermost layer in the anti-reflection film, and a color difference of reflected light, with respect to incident light from an artificial light source, between at a first point on the low refractive index layer and at a second point disposed 10 mm apart from the first point in a longitudinal or crosswise direction of the anti-reflection film is 2.0 or less as calculated in terms of ΔEab* value of CIE.
15. A polarizing plate comprising: a polarizing film; and at two surface protective films, at least one of the two surface protective films comprising an anti-reflection film defined in any one of Clauses 1 to 14.
16. The polarizing plate as defined in Clause 15, wherein one film of the two surface protective films comprises the anti-reflection film, the other film of the two surface protective films is an optical compensation film having an optical compensation layer comprising an optically anisotropic layer on an opposite side of the other film from the polarizing film, and the optically anisotropic layer comprises a compound having a discotic structural unit, wherein a disc surface of the discotic structure unit is disposed obliquely to a surface of the other film, and an angle of the disc surface of the discotic structure unit with respect to the surface of the other film changes in a depth direction of the optically anisotropic layer.
17. A liquid crystal display comprising at least one sheet of polarizing plate defined in Clause 15 or 16.
18. A method of producing an anti-reflection film of any one of Clauses 1 to 14, which comprises: reverse-roll coating a coating solution of a hard coat layer of the anti-reflection film using a microgravure coating method; drying a solvent away with heated drying air; and heating the coating solution or irradiating the coating solution with ionized radiation to cure the coating solution.
19. The method of producing an anti-reflection film as defined in Clause 18, wherein the coating solution comprises: the transparent resin; and a solvent having a boiling point of 100° C. or less.
20. The method of producing an anti-reflection film as defined in Clause 18 or 19, wherein the drying of the solvent away is performed with the heated drying air at a wind velocity of 1 m/sec or more.

An anti-reflection film of the invention has an improvement in resistance to unevenness in interference particularly when observed under an artificial illumination, has no problems with handling such as curling and brittleness, exhibits sufficient anti-reflection properties and scratch resistance and can be obtained with a high productivity. Therefore, a display such as liquid crystal device including an anti-reflection film of the invention provided optionally with a polarizing plate interposed therebetween has a remarkable improvement in resistance to unevenness in interference due to hard coat layer when used under an artificial illumination such as three wavelength tube, exhibits an extremely excellent scratch resistance, causes little reflection of external light or background and shows an extremely high viewability.

### BRIEF DESCRIPTION OF THE DRAWINGS

FIG. 1 is a sectional view diagrammatically illustrating the layer configuration of a non-limiting, illustrative embodiment of an anti-reflection film of the invention;

FIG. 2 is a sectional view diagrammatically illustrating the layer configuration of a non-limiting, illustrative embodiment of a multi-layer anti-reflection film of the invention;

FIG. 3 is a graph illustrating the color (a*,b*) of reflected light versus the thickness of a hard coat layer;

FIG. 4 is a graph illustrating the calculated value of change ΔEab* from the average color; and

FIG. 5 is a graph illustrating the reflection spectrum in the case where the thickness of a hard coat layer is 6.2 μm, where the color change ΔEab* is minimum, and the spectrum of CIE F12 light source.

### DETAILED DESCRIPTION OF THE INVENTION

A basic configuration of an exemplary embodiment of an anti-reflection film of the invention will be described hereinafter in connection with the attached drawings. In the present specification, in the case where the numerical values indicate physical values, properties or the like, the term “(value 1) to (value 2)” as used herein is meant to indicate “not smaller than (value 1) to not greater than (value 2)”. The term “(meth)acryloyl” as used herein is meant to indicate “at least any of acryloyl and methacryloyl”. This can apply to “(meth)acrylate”, “(meth)acrylic acid”, etc.

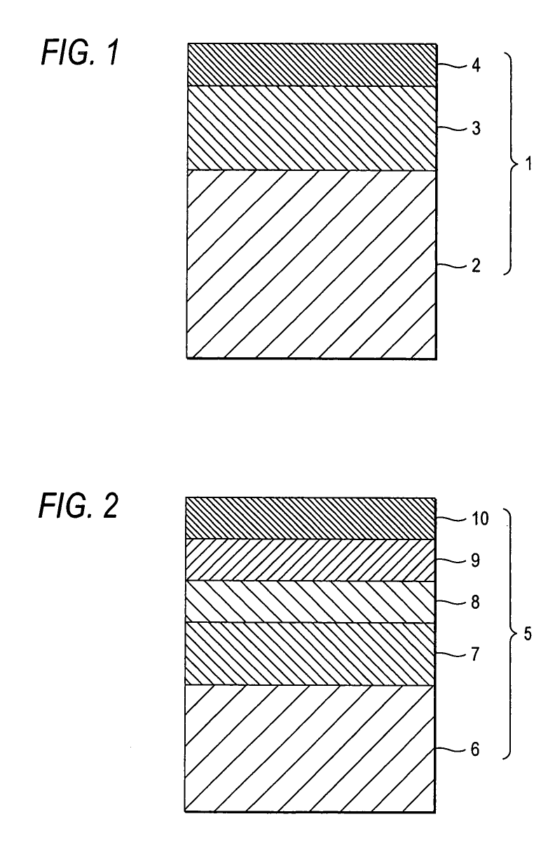

FIG. 1 is a sectional view grammatically illustrating an exemplary embodiment of an anti-reflection film of the invention. The present embodiment is a preferred embodiment of a single-layer anti-reflection film comprising only a low refractive index layer as an anti-reflection layer. This single-layer anti-reflection film undergoes less unevenness in interference and exhibits an excellent resistance to brittleness and curling.

An anti-reflection film 1 according to the present embodiment shown in FIG. 1 comprises a transparent support 2, a hard coat layer 3 formed on the transparent support 2, and a low refractive index layer 4 formed on the hard coat layer 3.

In the present embodiment, the hard coat layer may be provided on the transparent support directly or with other layers such as antistatic layer and moisture-proof layer interposed therebetween.

FIG. 2 is a sectional view grammatically illustrating another exemplary embodiment of an anti-reflection film of the invention. The present embodiment is a preferred example of a multi-layer anti-reflection film. The multi-layer anti-reflection film 5 comprises as anti-reflection layers three layers, i.e., a middle refractive index layer 8 having a refractive index higher than that of the transparent support 6 and the hard coat layer 7 and lower than that of the high refractive index layer 9, a high refractive index layer 9 having the highest refractive index among all the layers, and a low refractive index layer 10 having the lowest refractive index among all the layers. The anti-reflection film according to the present embodiment exhibits an average reflectance as low as 0.5% and thus can be preferably used in television, monitor, etc.

Referring to the optical properties of the anti-reflection film according to the present embodiment, the specular reflectance and the transmittance of the anti-reflection film are preferably 0.5% or less and 90% or more, respectively, to inhibit the reflection of external light and hence enhance viewability.

The aforementioned hard coat layer will be further described hereinafter.

(Hard Coat Layer)

The hard coat layer is formed for the purpose of compensating the low indentation elasticity of the transparent support made of plastic film and hence providing the film with scratch resistance as evaluated by pencil scratch or the like.

The difference in tint between two arbitrary points (i.e., first and second points) apart from each other at a distance along the longitudinal or crosswise directions on the film of the invention corresponds to the ease of visual observation of unevenness in coating (stepwise unevenness in coating roll pitch, transfer of the shape of drying roll pitch, etc. if the two points are longitudinally apart from each other; coat streak, unevenness in air wind mark, etc. if the two points are crosswise apart from each other) occurring at a frequency corresponding to substantially the same distance as the distance between the two points apart longitudinally or crosswise from each other. In particular, the unevenness in thickness of the hard coat layer has never been noticed. It was found that the unevenness in thickness of the hard coat layer has a great effect on the unevenness in tint of reflected light particularly when the light source is an artificial light source. The invention has thus been worked out.

The term “artificial illumination” as used herein is meant to indicate an illumination comprising a three wavelength fluorescent lamp or light-emitting diode. Unlike sunshine, the light ray from these artificial illuminations is composed of three primaries, i.e., R (red), G (green) and B (blue). For example, as three wavelength fluorescent tubes there are commercially available Palook fluorescent lamps (three-wavelength light-emitting type, produced by Matsushita Electric Industrial Co., Ltd.) such as FL40SS•EX-L/37, FL40SS•ELW/37, FL40SS•EX-N/37, FL40SS•ENW/37, FL40SS•EX-D/37, FL40SS•ECW/37, FL20SS•EX-L/18, FCL30•EX-L/28 and FL20SS•ELW/18.

These illuminations are particularly composed of blue (wavelength: 435 nm), green (wavelength: 545 nm) and red (wavelength: 610 nm). In the case where the anti-reflection film comprising a hard coat layer having a thickness of 5 μm or more is observed for unevenness in tint of reflected light on the surface thereof under such an artificial illumination with reflection from the back surface thereof interrupted, since the waveform of reflection spectrum of the hard coat layer oscillates finely in the wavelength range in the vicinity of these three main wavelengths at which maximum spectrum is reached, the reflectance of light at the three main wavelengths at which maximum spectrum is reached shows a sudden change, e.g., from minimum to maximum and then again to minimum, when a minute thickness change causes slight shift of wavelength at which minimum spectrum is reached and wavelength at which maximum spectrum is reached to longer or shorter wavelength. As a result, the difference of amount of reflected light having wavelength corresponding to that of the three primaries increases, causing the rise of color change. It is thus thought that the unevenness in thickness of the hard coat layer causes the worsening of unevenness in color.

The term “reflectance” as used herein is meant to indicate that measured on the reflection only on the surface of the film with the reflection on the back surface of the film cut by (a) sticking a black film to the back surface of the film, (b) roughening the back surface of the film with a file and then spreading a black ink over the roughened surface of the film, (c) sticking the back surface of the film to the surface of a set of polarizing plates laminated on each other in crossed nicols, or the like. When an anti-reflection film having an anti-reflection layer provided on a hard coat layer is observed with reflection on the back surface thereof interrupted, it is made obvious that the unevenness in color attributed to unevenness in thickness of the hard coat layer accounts for the majority of the unevenness in color of the film. It is also made obvious that the unevenness in color becomes more remarkable than when observed only on the hard coat layer.

The color difference of reflected light on the hard coat layer with respect to an incident light from an artificial light source between at an arbitrary point (a first point) on the hard coat layer of the invention and another arbitrary point (second point) disposed 5 mm apart therefrom in the film longitudinal or crosswise direction is preferably 2.0 or less, more preferably 1.0 or less, even more preferably 0.5 or less as calculated in terms of ΔE value. The color difference of reflected light on the hard coat layer with respect to an incident light from an artificial light source between at an arbitrary point on the hard coat layer of the invention and two other arbitrary points disposed 10 mm and 30 mm apart therefrom, respectively, in the film longitudinal or crosswise direction is preferably 2.0 or less, more preferably 1.0 or less, even more preferably 0.5 or less as calculated in terms of ΔE value. Further, the color difference of reflected light on the low refractive index layer formed as an outermost layer in the anti-reflection layer from that of an artificial light source between at an arbitrary point on the low refractive index layer and three other arbitrary points disposed 5 mm, 10 mm and 30 mm apart therefrom, respectively, in the film longitudinal or crosswise direction is preferably 2.0 or less as calculated in terms of ΔEab* value of CIE.

It is generally said that when the color difference is 1.5 or less as calculated in terms of ΔEab* value, it cannot be visually observed. However, the color difference depends also on the kind of the light source used, amount of light, difference of observer, etc. Therefore, the color difference is preferably as small as described above.

The ratio nh/nb of refractive index nh of the hard coat layer of the invention to refractive index nb of the aforementioned support is preferably from 0.97 to 1.05. The aforementioned color difference of reflected light with respect to the artificial light source is attributed to the difference in color of interfering light caused by the difference in thickness of hard coat layer between two arbitrary points. When the ratio nh/nb of refractive index nh of the hard coat layer to refractive index nb of the aforementioned support is 1 or there is no unevenness in thickness, there occurs no color difference. However, in order to actually form the hard coat layer, a step of wet-spreading a coating composition and drying the coat layer with a drying air to remove the solvent is needed. At this step, there unavoidably occurs some unevenness in thickness. Referring to refractive index, when a triacetyl cellulose film for example is used as a transparent substrate, the resulting substrate exhibits a refractive index of from 1.48 to 1.49. As materials constituting the hard coat layer for anti-reflection film, there are no materials having such a refractive index. Actually, a material having a refractive index somewhat higher than that of the transparent support must be selected. It is thus desirable that unevenness in interference occurring when a certain unevenness in thickness occurs be inhibited by predetermining the refractive index ratio within the above defined range.

The hard coat layer of the invention mainly includes an ionized radiation-curing resin. The thickness (dry thickness) of the hard coat layer falls within the range of from 5 to 15 μm, preferably from 6 to 15 μm. For the measurement of the thickness of the hard coat layer, fitting of reflection spectrum described later may be executed. When the thickness of the hard coat layer falls within the above defined range, unevenness in interference can be eliminated, an effect of improving indentation elasticity can be exerted, and the number of point defects on the surface of the hard coat layer attributed to the occurrence of foreign matters having a particle diameter of few micrometers can be reduced. Further, the anti-reflection film having a hard coat film or anti-reflection layer formed thereon undergoes little curling and thus exhibits a good handleability at the subsequent steps. Moreover, the anti-reflection film thus obtained also exhibits an excellent flexibility and brittleness and hence an excellent workability.

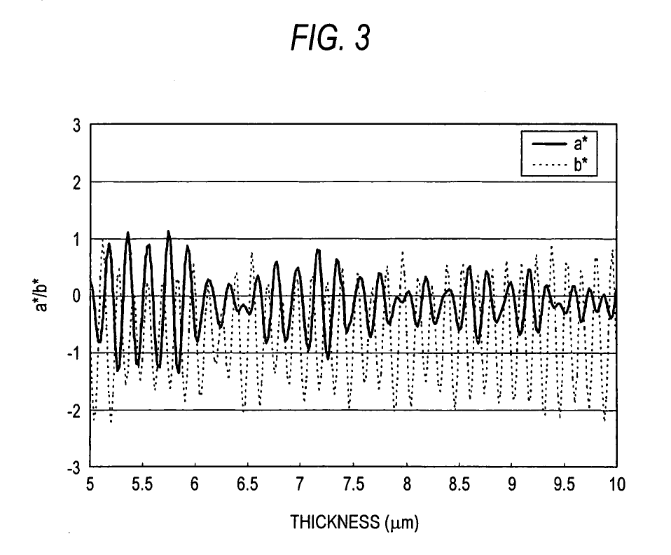

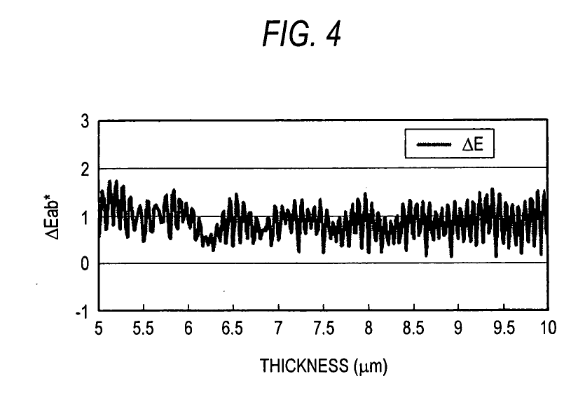

Further, when the thickness of the hard coat layer falls within the above defined range, there are scattered desirable regions where the unevenness in interference (color change) with the change of the thickness of the hard coat layer in particular is small. For example, FIGS. 3 and 4 each are a graph obtained by plotting the color of reflected light (L* (not shown), a*, b*, FIG. 3) with respect to F12 light source of CIE (three wavelength fluorescent lamp) determined from reflection spectrum obtained by the calculation of reflectance with respect to 5 degree incident light every 1 nm over a wavelength range of from 380 to 780 nm versus the thickness of the hard coat layer varying by 20 nm over a range of from 5 to 10 μm supposing that A value, B value and C value are 1.505, 0.500 and 0, respectively, when the refractive index of the support is 1.486 (refractive index of triacetyl cellulose measured by Abbe refractometer) and the refractive index of the hard coat layer is subjected to Cauchy approximation and plotting the color change ΔEab* calculated with the average value of L*, a* and b* (average color) within the aforementioned thickness range as reference (FIG. 4) versus the thickness of the hard coat layer. Both a* and b* values oscillate at a constant frequency. Since the frequency of oscillation of b* value is shorter than that of a* value, the peak of both a* and b* values, the peak of a* value or b* value and the valley of b* value or a* value and the valley of both a* and b* values overlap each other at a certain frequency. There is a desirable region where the color change ΔEab* is small at the same frequency as that of overlapping, i.e., in the vicinity of thickness 6.2 μm, 6.9 μm, 7.6 μm, 8.3 μm. In the invention, the range of thickness of the hard coat layer where the amplitude of waveform in graph is minimum is defined, e.g., by the thickness range where the absolute value of the difference between four or more continuous peaks and four or more continuous valley or between four or more continuous valleys and four or more continuous peaks of the color change ΔEab* curve is not more than 1.0 in FIG. 4.

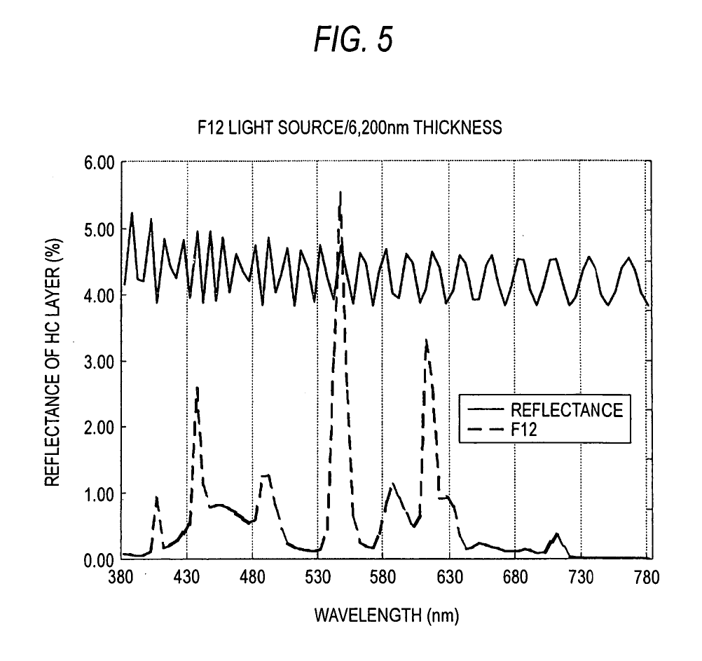

The reflection spectrum of the hard coat layer having a thickness of 6.2 μm, where the color change ΔEab* is smallest in FIG. 4, and CIE F12 light source are shown in FIG. 5.

From the standpoint of yield obtained when applied to polarizing plate and liquid crystal display, the number of point defects having a size of 50 μm or more per m² on the surface of the hard coat layer is preferably 5 or less.

<Transparent Resin (Light-Transmitting Resin)>

The transparent resin (light-transmitting resin) to be incorporated in the hard coat layer is preferably a binder polymer having a saturated hydrocarbon chain or polyether chain as a main chain, more preferably a binder polymer having a saturated hydrocarbon chain as a main chain. The binder polymer preferably has a crosslinked structure.

The binder polymer having a saturated hydrocarbon chain as a main chain is preferably a polymer of ethylenically unsaturated monomers. The binder polymer having a saturated hydrocarbon chain as a main chain and a crosslinked structure is preferably a (co)polymer of monomers having two or more ethylenically unsaturated groups.

Examples of the monomer having two or more ethylenically unsaturated groups which is used as a main component include esters of polyvalent alcohol with (meth)acrylic acid (e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipenta erythritol tetra(meth)acrylate, dipentaerythritol penta(meth)acrylate, dipentaerythritol hexa(meth)acrylate, pentaerythritol hexa(meth)acrylate, 1,2,3-cyclohexatetramethacrylate, polyurethane polyacrylate, polyester polyacrylate), ethylene oxide modification products, propylene oxide modification products and caprolactone modification products of the aforementioned esters, vinylbenzene and derivatives thereof (e.g., 1,4-divinylbenzene, 4-vinylbenzoic acid-2-acryloylethylester, 1,4-divinylcyclohexanone), vinylsulfones (e.g., divinylsulfone), acylamides (e.g., methylene bisacrylamide), and methacrylamides. Two or more of these monomers are preferably used in admixture for the sake of design of formulation to well balance the indentation elasticity, etc. and the curling resistance of the hard coat layer having the designed thickness.

<Photopolymerization Initiator>

The polymerization of these light-transmitting resins is initiated by irradiating the following photoradical polymerization initiator with ionized radiation. Examples of the photoradical polymerization initiator include acetophenones, benzoins, benzophenones, phosphine oxides, ketals, anthraquinones, thioxanetones, azo compounds, peroxides, 2,3-dialkyldione compounds, disulfide compounds, fluoroamine compounds, and aromatic sulfoniums. Examples of the acetophenones include 2,2-diethoxyacetophenone, p-dimethylacetophenone, 1-hydroxydimethylphenylketone, 1-hydroxycyclohexyl phenyl ketone, 2-methyl-4-methylthio-2-morpholino propiophenone, and 2-benzyl-2-dimethylamino-1-(4-morpholinophenyl)-butanone. Examples of the benzoins include benzoinbenzenesulfonic acid ester, benzoin toluenesulfonic acid ester, benzoin methyl ether, benzoinethyl ether, and benzoin isopropyl ether. Examples of the benzophones include benzophenone, 2,4-dichlorobenzophenone, 4,4-dichlorobenzophenone, and p-chlorobenzophenone. Examples of the phosphine oxides include 2,4,6-trimethylbenzoyl diphenyl phosphine oxide.

Various examples are disclosed in Kazuhiro Takahashi, “Saishin UV Koka Gijutsu (Newest UV Curing Technique)”, TECHNICAL INFORMATION INSTITUTE CO., LTD., page 159, 1991. These examples are useful in the invention.

Preferred examples of commercially available photocleavable photoradical polymerization initiators include Irgacure (651, 184, 907) (produced by Nihon Ciba-Geigy K.K.).

The photopolymerization initiator is preferably used in an amount of from 0.1 to 15 parts by weight, more preferably from 1 to 10 parts by weight based on 100 parts by weight of polyfunctional monomer.

In addition to the photopolymerization initiator, a photosensitizer may be used. Specific examples of the photosensitizer include n-butylamine, triethylamine, tri-n-butylphosphine, Michler's ketone, and thioxanthone.

In addition to the incorporation of the aforementioned monomers, a monomer having a crosslinkable functional group may be used to incorporate a crosslinkable functional group in the polymer whereby the reaction of the crosslinkable functional group causes the incorporation of a crosslinked structure in the binder polymer.

Examples of the crosslinkable functional group include isocyanate groups, epoxy groups, aziridine groups, oxazoline groups, aldehyde groups, carbonyl groups, hydrazine groups, carboxyl groups, methylol groups, and active methylene groups. A vinylsulfonic acid, an acid anhydride, a cyano acrylate derivative, a melamine, an etherified methylol, an ester, an urethane or a metal alkoxide such as tetramethoxysilane may be used as a monomer for the incorporation of a crosslinked structure. A functional group which exhibits crosslinkability as a result of decomposition reaction such as blocked isocyanate group may be used. In other words, the crosslinkable functional group to be used in the invention may be not immediately reactive but may be reactive as a result of decomposition reaction.

These binder polymers having a crosslinkable functional group may form a crosslinked structure when heated after being spread.

<Surfactant>

The hard coat layer-forming coating composition of the invention may comprise either or both of a fluorine-based surfactant and a silicone-based surfactant incorporated therein to assure uniformity in surface conditions such as coating uniformity, drying uniformity and point defect. In particular, a fluorine-based surfactant is preferably used because it can exert an effect of eliminating defects in surface conditions such as coating unevenness, drying unevenness and point defect.

The surfactant is intended to render the hard coat layer-forming coating composition adaptable to high speed coating while enhancing the uniformity in surface conditions so as to enhance the productivity.

Preferred examples of the fluorine-based surfactant include fluoroaliphatic group-containing copolymers (hereinafter occasionally abbreviated as “fluorine-based polymer”). Useful examples of the fluorine-based polymer include acrylic resins and methacrylic resins containing repeating units corresponding to the following monomer (i) and repeating units corresponding to the following monomer (ii), and copolymers of these monomers with vinyl-based monomers copolymerizable therewith.
(i) Fluoroaliphatic group-containing monomer represented by the following formula (3): 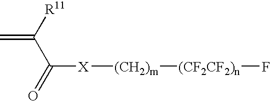
wherein R¹¹ represents a hydrogen atom or methyl group; X represents an oxygen atom, sulfur atom or —N(R¹²)— in which R¹² represents a hydrogen atom or a C₁-C₄ alkyl group such as methyl, ethyl, propyl and butyl, preferably hydrogen atom or methyl; m represents an integer of from 1 to 6; and n represents an integer of 2 or 3. X is preferably an oxygen atom. The suffix m is particularly preferably 2.

As a fluoroaliphatic group-containing monomer (i) there may be used a mixture of monomers represented by the formula (3) wherein n is 2 and 3 may be used.
(ii) Monomer represented by the following formula (4) copolymerizable with the monomer (i). 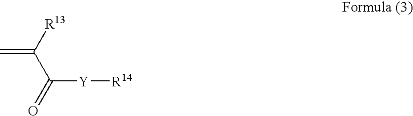
wherein R¹³ represents a hydrogen atom or methyl group; and Y represents an oxygen atom, sulfur atom or —N(R¹⁵)— in which R¹⁵ represents a hydrogen atom or a C₁-C₄ alkyl group such as methyl, ethyl, propyl and butyl, preferably hydrogen atom or methyl. Y is preferably an oxygen atom, —N(H)— or —N(CH₃)—.

R¹⁴ represents a C₄-C₂₀ straight-chain, branched or cyclic alkyl group which may have substituents. Examples of the substituents on the alkyl group represented by R¹⁴ include hydroxyl groups, alkylcarbonyl groups, arylcarbonyl groups, carboxyl groups, alkylether groups, arylether groups, halogen atoms such as fluorine atom, chlorine atom and bromine atom, nitro group, cyano group, and amino group. The invention is not limited to these substituents. As the C₄-C₂₀ straight-chain, branched or cyclic alkyl group there may be preferably used butyl, pentyl, hexyl, heptyl, octyl, nonyl, decyl, undecyl, dodecyl, tridecyl, tetradecyl, pentadecyl, octadecyl or eicosanyl group which may be straight-chain or branched, a monocyclic cycloalkyl or bicycloheptyl group such as cyclohexyl and cycloheptyl or polycyclic cycloalkyl group such as bicycloheptyl, bicyclodecyl, tricycloundecyl, tetracyclododecyl, adamanthyl, norbonyl and tetracyclodecyl.

The proportion of the fluoroaliphatic group-containing monomer represented by the formula (3) in the amount of fluorine-based polymer to be used in the invention is 10 mol-% or more, preferably from 15 to 70 mol-%, more preferably from 20 to 60 mol-%. The term “proportion of amount of monomer” as used herein is meant to indicate the proportion of amount of polymerizing unit derived from the monomer and constituting the fluorine-based polymer.

The weight-average molecular weight of the fluorine-based polymer to be used in the invention is preferably from 3,000 to 100,000, more preferably from 5,000 to 80,000.

The added amount of the fluorine-based polymer to be used in the invention is preferably from 0.001 to 5% by weight, more preferably from 0.005 to 3% by weight, even more preferably from 0.01 to 1% by weight based on the weight of the coating solution taking into account sufficient development of effect, dryability of coat layer and properties of coat layer (e.g., reflectance, scratch resistance).

Specific examples of the structure of fluorine-based polymer according to the invention will be given below, but the invention is not limited thereto. The figure in the following formulae indicates the molar fraction of the various monomer components. Mw indicates the weight-average molecular weight.

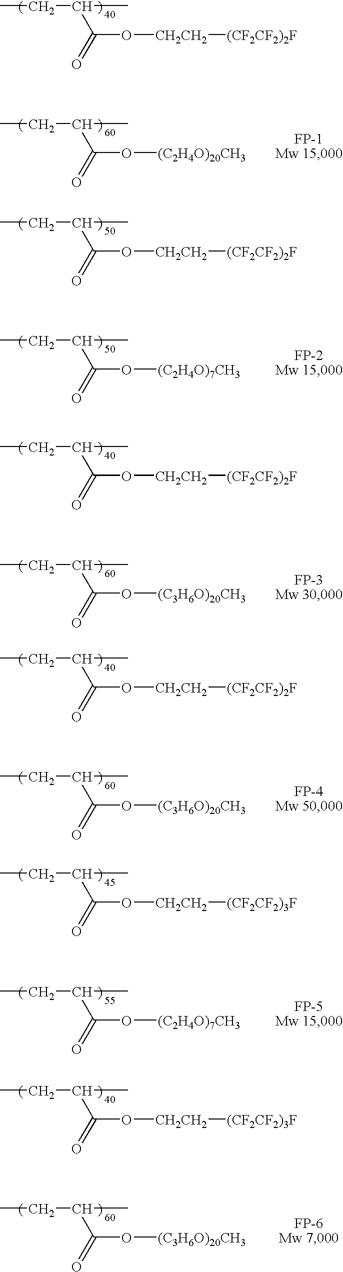

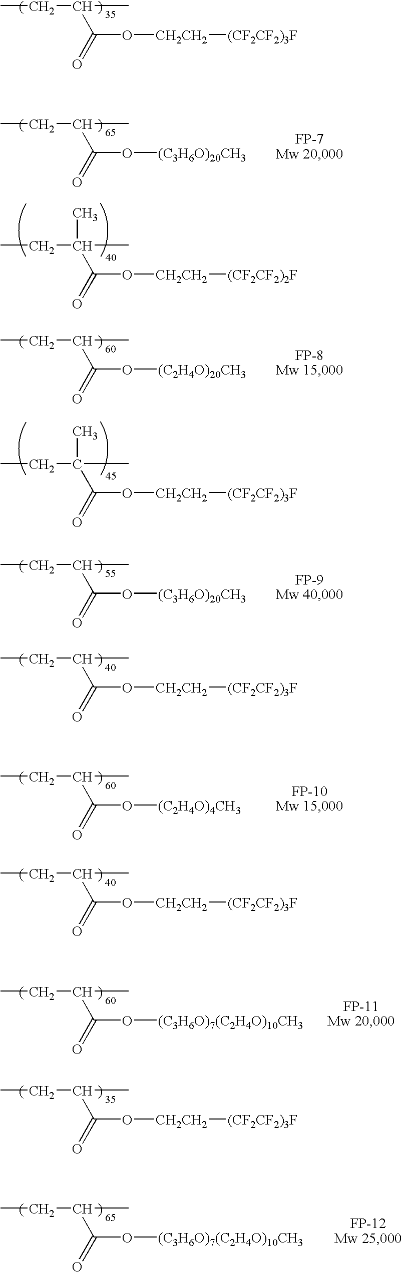

Alternatively, as the upper layer-forming composition there can be selected a fluorine-based polymer which can be extracted with the solvent for use in the formation of the upper layer. In this manner, the upper layer-forming composition can be prevented from being unevenly distributed on the surface, i.e., interface of the lower layer, causing the upper layer and the lower layer adhesive to each other. Therefore, the surface conditions can be kept uniform even when coating is effected at a high speed. Further, an anti-reflection film having a high scratch resistance can be provided. An example of such a material is represented by the following formula (5).
(i) Fluoroaliphatic group-containing monomer represented by the following formula (5): 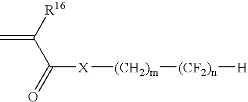
wherein R¹⁶ represents a hydrogen atom, halogen atom or methyl group, preferably hydrogen atom or methyl group; X represents an oxygen atom, sulfur atom or —N(R¹⁷)— (in which R¹⁷ represents a hydrogen atom or C₁-C₈ alkyl group which may have substituents, preferably hydrogen atom or C₁-C₄alkyl group, more preferably hydrogen atom or methyl group), preferably oxygen atom or —N(R¹⁷)—, particularly oxygen atom; m represents an integer of from 1 to 6; and n represents an integer of from 1 to 18. X is preferably an oxygen atom.

The suffix m is preferably an integer of from 1 to 3, more preferably 1. The suffix n is preferably an integer of from 4 to 12, more preferably from 6 to 8.

The fluorine-based polymer may comprise as constituents two or more polymerizing units derived from fluoroaliphatic group-containing monomers represented by the formula (5).
(ii) Monomer represented by the following formula (6) copolymerizable with the monomer (i). 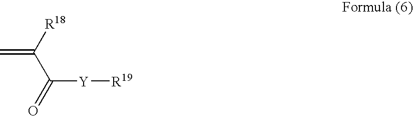
wherein R¹³ represents a hydrogen atom, halogen atom or methyl group, preferably hydrogen atom or methyl group; Y represents an oxygen atom, sulfur atom or —N(R²⁰)—, preferably oxygen atom or —N(R²⁰)—, more preferably oxygen atom; and R²⁰ represents a hydrogen atom or C₁-C₈ alkyl group, preferably hydrogen atom or C₁-C₄ alkyl group, more preferably hydrogen atom or methyl group.

R¹⁹ represents a C₁-C₂₀ straight-chain, branched or cyclic alkyl group which may have substituents, an alkyl group containing a poly(alkyleneoxy) group or an aromatic group which may have substituents (e.g., phenyl, naphthyl), preferably C₁-C₁₂ straight-chain, branched or cyclic alkyl group, more preferably an aromatic group having from 6 to 18 carbon atoms in total, even more preferably C₁-C₈ straight-chain, branched or cyclic alkyl group.

The amount of the fluoroaliphatic group-containing monomers represented by the formula (5) in the fluororesin-based polymer comprising as polymerizing units fluoroaliphatic group-containing monomers represented by the formula (5) is preferably more than 50% by weight, more preferably from 70 to 100% by weight, even more preferably from 80 to 100% by weight based on the total amount of polymerizing units constituting the fluorine-based polymer.

The amount of the monomer polymerizing unit represented by the formula (6) which can be preferably used in the invention is preferably less than 50% by weight, more preferably from 0 to 30% by weight, even more preferably from 0 to 20% by weight based on the total amount of polymerizing units constituting the fluoropolymer.

<Solvent>

Since there is a case where the coating solution of the hard coat layer of the invention is wet-spread directly over the transparent support, the solvent to be used in the coating composition is an important factor. Examples of the requirements for the solvent include sufficient dissolution of various solutes, no occurrence of unevenness in coating and drying during the steps of coating to drying, no dissolution of support (necessary for the prevention of defects such as deterioration of flatness and whitening) and swelling of support to the least extent (necessary for adhesion).

In some detail, in the case where as the support there is used a triacetyl cellulose, various ketones (e.g., methyl ethyl ketone, acetone, methyl isobutyl ketone, cyclohexanone), various cellosolves (e.g., ethyl cellosolve, butyl cellosolve, propylene glycol monomethyl ether), solvents having a high dissolving power for adjusting swelling properties such as methyl acetate and ethyl acetate, solvents which can difficulty cause swelling such as methanol, ethanol, propanol, isopropanol, butanol, 2-butanol and tert-butanol, etc. may be used in proper admixture.

In order to inhibit the interference unevenness in the hard coat layer, it is preferred that at least one solvent having a boiling point of 100° C. or less, preferably 95° C. or less, more preferably 90° C. or less be included. Particularly preferred among the aforementioned solvents are methyl ethyl ketone, acetone, methanol, ethanol, propanol, isopropanol, 2-butanol and tert-butanol, which have a boiling point of 100° C. or less.

The aforementioned low refractive index layer will be further described hereinafter.

<Low Refractive Index Layer>

The refractive index of the low refractive index layer in the anti-reflection film of the invention is preferably from 1.30 to 1.55, more preferably from 1.35 to 1.45.

When the refractive index of the low refractive index layer falls within the above defined range, the resulting low refractive index layer is excellent in anti-reflection properties and film mechanical strength.

The low refractive index layer preferably satisfies the following relationship (I) from the standpoint of reduction of reflectance.
(m/4)×0.7<n1×d1<(m/4)×1.3 (I)
wherein m represents a positive odd number; n1 represents the refractive index of the low refractive index layer; and d1 represents the thickness (nm) of the low refractive index layer. λ indicates wavelength falling within a range of from 500 to 550 nm.

The satisfaction of the aforementioned relationship (I) means that there is m (positive odd number, normally 1) satisfying the relationship (I) in the above defined range of wavelength.

The material constituting the low refractive index layer will be further described hereinafter.

The low refractive index layer in the anti-reflection film of the invention is formed by a coating composition comprising a binder component, a small amount of additives and a solvent. The binder component is preferably one having a low refractive index such as fluoropolymer and particulate inorganic material described later. In order to enhance the cohesive force of the layer, the low refractive index layer may comprise any of an organosilane compound and hydrolyzate and condensate thereof (referred to as “sol component”), a curable compound or the like incorporated therein as a part of binder component. Alternatively, a sol component may be used as a main component to form a sol-gel layer. The binder component, if used as a sol-gel layer, preferably has a partly or fully fluorine-substituted alkyl group. Examples of the additives to be used in a small amount include stain proofing agents, lubricants, dustproofing agents, antistatic agents, and polymerization initiators.

<Fluorine-Containing Polymer>

In a preferred embodiment of the low refractive index layer of the invention, as the low refractive binder there is incorporated a fluorine-containing polymer. The fluorine-containing polymer is preferably one having a dynamic friction coefficient of from 0.03 to 0.20, a contact angle of from 90° to 120° with respect to water and a pure water slipping angle of 70° or less which undergoes crosslinking when heated or irradiated with ionized radiation. In order to reduce the refractive index of the low refractive index layer and provide the low refractive index layer with cohesive force and adhesion to the underlying layer, the fluorine-containing polymer preferably contains fluorine atoms in an amount of from 35 to 80% by weight. In the case where the anti-reflection film of the invention is mounted on an image display, the lower the peeling force of the low refractive index layer is, the more can be easily peeled a seal or adhesive memo pad off the low refractive index layer. The peeling force of the low refractive index layer with respect to these materials is preferably 500 gf or less, more preferably 300 gf or less, most preferably 100 gf or less. The higher the surface hardness of the low refractive index layer as measured by a microhardness tester is, the more difficulty can be scratched the low refractive index layer. The surface hardness of the low refractive index layer is preferably 0.3 GPa or more, more preferably 0.5 GPa or more.

Examples of the fluorine-containing polymer to be used in the low refractive index layer include hydrolyzates and dehydration condensates of perfluoroalkyl group-containing silane compounds, and fluorine-containing copolymers comprising a fluorine-containing monomer unit and a constituent unit for providing crosslinking reactivity.

Other preferred examples of the fluorine-containing monomer unit include fluoroolefins (e.g., fluoroethylene, vinylidene fluoride, tetrafluoroethylene, perfluorooctylethylene, hexafluoropropylene, perfluoro-2,2-dimethyl-1,3-dioxol), partly or fully fluorinated alkylester derivatives of (meth)acrylic acid (e.g., Biscoat 6FM (produced by OSAKA ORGANIC CHEMICAL INDUSTRY LTD.), M-2020 (produced by DAIKIN INDUSTRIES, Ltd.)), and fully or partly-fluorinated vinyl ethers. Preferred among these fluorine-containing monomers are perfluoroolefins. Particularly preferred among these fluorine-containing monomers is hexafluoropropylene from the standpoint of refractive index, solubility, transparency, availability, etc.

Examples of the constituent unit for providing crosslinking reactivity include constituent units obtained by the polymerization of monomers previously having a self-crosslinkable functional group in molecule such as glycidyl(meth)acrylate and glycidyl vinyl ether, constituent units obtained by the polymerization of monomers having carboxyl group, hydroxyl group, amino group, sulfo group, etc. (e.g., (meth)acrylic acid, methylol(meth)acrylate, hydroxyalkyl(meth)acrylate, allyl acrylate, hydroxyethyl vinyl ether, hydroxybutyl vinyl ether, maleic acid, crotonic acid), and constituent units obtained by introducing a crosslinkable functional group such as (meth)acryloyl group into these constituent units by a polymer reaction (e.g., method involving the reaction of hydroxyl group with acrylic acid chloride).

Besides the aforementioned fluorine-containing monomer units and constituent units for providing crosslinking reactivity, fluorine-free monomers may be properly copolymerized from the standpoint of solubility in solvent, transparency of film, etc. The monomers to be used in combination with the aforementioned constituent units are not specifically limited. Examples of these monomers include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (methyl methacrylate, ethyl methacrylate, butyl methacrylate, ethylene glycol dimethacrylate), styrene derivatives (e.g., styrene, divinyl benzene, vinyl toluene, α-methylstyrene), vinyl ethers (e.g., methyl vinyl ether, ethyl vinyl ether, cyclohexyl vinyl ether), vinyl esters (e.g., vinyl acetate, vinyl priopionate, vinyl cinnamate), acrylamides (e.g., N-tert butylacrylamide, N-cyclohexyl acrylamide), methacrylamides, and acrylonitrile derivatives.

The aforementioned polymers may be used properly in combination with a curing agent as disclosed in JP-A-10-25388 and JP-A-10-147739.

The fluorine-containing polymer which is particularly preferred in the invention is a random copolymer of perfluoroolefin with vinyl ether or vinyl ester. It is particularly preferred that the fluorine-containing polymer have a group which can undergo crosslinking reaction by itself (e.g., radical-reactive group such as (meth)acryloyl group, ring-opening polymerizable group such as epoxy group and oxetanyl group). These crosslinkable functional group-containing polymerizing units preferably account for from 5 to 70 mol-%, particularly from 30 to 60 mol-% of the total polymerizing units of the polymer.

A preferred embodiment of the copolymer to be used in the invention is one represented by the following formula (1):

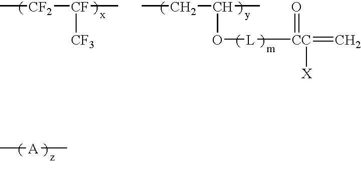

In the formula (1), L represents a C₁-C₁₀ connecting group, preferably a C₁-C₆ connecting group, particularly C₂-C₄ connecting group. The connecting group may be straight-chain or may have a branched or cyclic structure. The connecting group may have hetero atoms selected from the group consisting of oxygen, nitrogen and sulfur.

Preferred examples of L include *—(CH₂)₂—O—**, *—(CH₂)₂—NH—**, *—(CH₂)₄—O—**, *—(CH₂)₆—O—**, *—(CH₂)₂—O—(CH₂)₂—**, *—CONH—(CH₂)₃—**, *—CH₂CH(OH)CH₂—O—**, and *—CH₂CH₂OCONH(CH₂)₃—O—** (in which * indicates the connecting site on the polymer main chain side and ** indicates the connecting site on the (meth)acryloyl group side). The suffix m represents 0 or 1.

In the formula (1), X represents a hydrogen atom or methyl group, preferably hydrogen atom from the standpoint of curing reactivity.

In the formula (1), the group A represents a repeating unit derived from arbitrary vinyl monomer. The repeating unit is not specifically limited so far as it is a constituent of a monomer copolymerizable with hexafluoropropylene. The repeating unit may be properly selected from the standpoint of adhesion to substrate, Tg of polymer (contributing to film hardness), solubility in solvent, transparency, slipperiness, dustproofness, stainproofness, etc. The repeating unit may be composed of a single or a plurality of vinyl monomers depending on the purpose.

Preferred examples of the aforementioned vinyl monomer include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether, vinyl esters such as vinyl acetate, vinyl propionate and vinyl butyrate, (meth)acrylates such as methyl (meth)acrylate, ethyl (meth)acrylate, hydroxyethyl (meth)acrylate, glycidyl methacrylate, allyl (meth)acrylate and (meth)acryloyloxypropyl trimethoxysilane, styrene derivatives such as styrene and p-hydroxymethylstyrene, unsaturated carboxylic acids such as crotonic acid, maleic acid and itaconic acid, and derivatives thereof. More desirable among these vinyl monomers are vinyl ether derivatives and vinyl ester derivatives. Particularly preferred among these vinyl monomers are vinyl ether derivatives.

The suffixes x, y and z each represent the molar percentage of the respective constituent component and satisfy the relationships 30≦x≦60, 5≦y≦70 and 0≦z≦65, preferably 35≦x≦55, 30≦y≦60 and 0≦z≦20, particularly 40≦x≦55, 40≦y≦55 and 0≦z≦10.

A particularly preferred embodiment of the copolymer to be used in the invention is one represented by the formula (2).

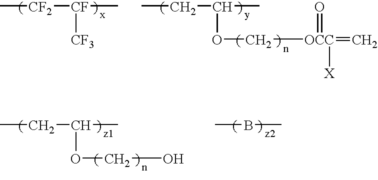

In the formula (2), X, x and y and their preferred range are as defined in the formula (1).

The suffix n represents an integer of from not smaller than 2 to not greater than 10, preferably from not smaller than 2 to not greater than 6, particularly from not smaller than 2 to not greater than 4.

The group B represents a repeating unit derived from arbitrary vinyl monomer. The repeating unit may be composed of a single composition or a plurality of compositions. Examples of the repeating unit include those listed above with reference to the group A in the formula (1).

The suffixes z1 and z2 each represent the molar percentage of the respective repeating unit and satisfy the relationship 0≦z1≦65 and 0≦z2≦65, preferably 0≦z1≦30 and 0≦z2≦10, particularly 0≦z1≦10 and 0≦z2≦5.

The copolymer represented by the formula (1) or (2) can be synthesized by introducing a (meth)acryloyl group into a copolymer comprising a hexafluoropropylene component and a hydroxyalkylvinyl ether component by any of the aforementioned methods.

As the reprecipitating solvent there is preferably used isopropanol, hexane, methanol or the like.

<Curable Compound>

As the curable compound there is preferably used a (meth)acrylate monomer. Examples of the (meth)acrylate monomer include esters of polyvalent alcohol with (meth)acrylic acid (e.g., ethylene glycol di(meth)acrylate, butanediol di(meth)acrylate, hexanediol di(meth)acrylate, 1,4-cyclohexane diacrylate, penaerythritol tetra(meth)acrylate, pentaerthritol tri(meth)acrylate, trimethylolpropane tri(meth)acrylate, dipentaerythritol tetra(meth)acrylate, dipentaerythritol penta(meth)acrylate, dipentaerythritol hexa(meth)acrylate, 1,2,3-cyclohexane tetramethacrylate, polyurethane polyacrylate, polyester polyacrylate, the aforementioned ethylene oxide modification products, vinyl benzene, derivatives thereof (e.g., 1,4-divinyl benzene, 4-vinylbenzoic acid-2-acryloylethyl ester, 1,4-divinylcyclohexanone), vinylsulfones (e.g., divinylsulfone), acrylamides (e.g., methylene bisacrylamide) and methacrylamides. The aforementioned monomers may be used in combination of two or more thereof. The added amount of these monomers may be adjusted by the content of materials having a low refractive index such as hollow particulate material and is preferably from 0 to 70% based on the total weight of the low refractive index layer. When the added amount of these monomers exceeds the above defined range, the refractive index of the layer is raised, making it impossible to design the desirable anti-reflection layer.

<Particulate Inorganic Material>

The low refractive index layer of the invention may comprise at least one particulate inorganic material incorporated therein.

The spread of the particulate inorganic material is preferably from 1 mg/m² to 100 mg/m², more preferably from 5 mg/m² to 80 mg/m², even more preferably from 10 mg/m² to 60 mg/m². When the spread of the particulate inorganic material is too small, the effect of improving scratch resistance is eliminated. On the contrary, when the spread of the particulate inorganic material is too great, fine roughness is produced on the surface of the low refractive index layer, causing the deterioration of the external appearance such as black tone and density and integrated reflectance.

The particulate inorganic material preferably has a low refractive index because it is incorporated in the low refractive index layer. Examples of the particulate inorganic material include particulate magnesium fluoride, and particulate silica. Particularly preferred among these particulate inorganic materials is particulate silica from the standpoint of refractive index, dispersion stability and cost. The average particle diameter of the particulate silica is preferably from not smaller than 30% to not greater than 150%, more preferably from not smaller than 35% to not greater than 80%, even more preferably from 40% to not greater than 60% of the thickness of the low refractive index layer. In some detail, when the thickness of the low refractive index layer is 100 nm, the particle diameter of the particulate silica is preferably from not smaller than 30 nm to not greater than 100 nm, more preferably from not smaller than 35 nm to not greater than 80 nm, even more preferably from not smaller than 40 nm to not greater than 60 nm.

When the particle diameter of the particulate silica falls within the above defined range, the resulting low refractive index layer exhibits an improved scratch resistance, undergoes inhibited occurrence of fine roughness on the surface thereof and shows a good external appearance such as black tone and density and a good integrated reflectance. The particulate silica may be crystalline or amorphous. The particulate silica may be monodisperse or may be composed of agglomerated particles so far as they have a predetermined particle diameter. The shape of the particulate silica is most preferably sphere but may be amorphous. The aforementioned properties of the particulate silica can be applied to other particulate inorganic materials.

For the measurement of the average particle diameter of the particulate inorganic material, a coulter counter may be used.

In order to further reduce the rise of the refractive index of the low refractive index layer, a hollow particulate silica is preferably used. The refractive index of the hollow particulate silica is preferably from 1.17 to 1.40, more preferably from 1.17 to 1.35, even more preferably from 1.17 to 1.30. The refractive index used herein means the refractive index of the entire particulate material rather than the refractive index of only the shell silica constituting the hollow particulate silica. Supposing that the radius of the bore of the particle is a and the radius of the shell of the particle is b, the percent void x represented by the following numerical formula (VIII) is preferably from 10% to 60%, more preferably from 20% to 60%, most preferably from 30% to 60%.
x=(4πa³/3)/(4πb³/3)×100 (VIII)

As the refractive index of the hollow particulate silica decreases and the percentage void of the hollow particulate silica rises, the thickness of the shell decreases and the strength of the particle lowers. Therefore, particulate materials having a refractive index as low as less than 1.17 are impossible from the standpoint of scratch resistance.

For the measurement of the refractive index of these hollow particulate silica materials, an Abbe refractometer (produced by ATAGO CO., LTD.) was used.

The aforementioned particulate silica (hereinafter referred to as “large particle size particulate silica”) may be used in combination with a particulate silica having an average particle diameter of less than 25% of the thickness of the low refractive index layer (hereinafter referred to as “small particle size particulate silica”).

The small particle size particulate silica can be present in the gap between the large size silica particles and thus can act as a retainer for large particle diameter particulate silica.

In the case where the thickness of the low refractive index layer is 100 nm, the average particle diameter of the small particle diameter particulate silica is preferably from not smaller than 1 nm to not greater than 20 nm, more preferably from not smaller than 5 nm to not greater than 15 nm, particularly from not smaller than 10 nm to not greater than 15 nm. The use of such a particulate silica is advantageous in material cost and effect of retainer.

The particulate silica may be subjected to physical surface treatment such as plasma discharge and corona discharge or chemical surface treatment with a surfactant, coupling agent or the like to enhance the stability of dispersion in the dispersion or coating solution or the affinity for or the bonding properties with the binder component. The coupling agent is particularly preferred. As the coupling agent there is preferably used an alkoxy metal compound (e.g., titanium coupling agent, silane coupling agent). Particularly effective among these surface treatments is silane coupling treatment.

The aforementioned coupling agent is used as a surface treatment for the inorganic filler in the low refractive index layer to effect surface treatment before the preparation of the layer coating solution. The coupling agent is preferably incorporated as additive in the low refractive index layer during the preparation of the layer coating solution.

It is preferred that the particulate silica be previously dispersed in the medium to reduce the burden of surface treatment.

<Organosilane, Sol Component>

The coating solution constituting low refractive index layer constituting the anti-reflection film of the invention preferably comprises an organosilane compound and/or hydrolyzate and partial condensate thereof, i.e., so-called gel component (hereinafter referred to as such) incorporated therein from the standpoint of scratch resistance. The coating solution comprising such a sol component is spread, dried, and then condensed at the heating step to form a cured material which acts as a binder for the low refractive index layer. In the case where the cured material has a polymerizable unsaturated bond, the cured material is irradiated with active light rays to form a binder having a three-dimensional structure. The formation of a sol-gel layer comprising as a main component a sol component obtained from a single or a plurality of organosilane compounds makes it possible to obtain a low refractive index layer excellent in scratch resistance.

The organosilane compound is preferably one represented by the following formula (3).
(R¹⁰)ₘ—Si(X)₄₋ₘ (3)

In the formula (3), R¹⁰ represents a substituted or unsubstituted alkyl or aryl group. The alkyl group preferably has from 1 to 30, more preferably from 1 to 16, particularly from 1 to 6 carbon atoms. Examples of the alkyl group include methyl, ethyl, propyl, isopropyl, hexyl, decyl, and hexadecyl. Examples of the aryl group include phenyl, and naphthyl. Preferred among these aryl groups is phenyl.

X represents a hydroxyl group or hydrolyzable group. Examples of these groups include alkoxy groups (preferably alkoxy groups having from 1 to 5 carbon atoms such as methoxy and ethoxy), halogen atoms (e.g., Cl, Br, I), and groups represented by R²COO (in which R² is preferably a hydrogen atom or C₁-C₅ alkyl group such as CH₃COO and C₂H₅COO). Preferred among these groups are alkoxy groups. Particularly preferred among these alkoxy groups are methoxy and ethoxy.

The suffix m represents an integer of from 1 to 3, preferably 1 or 2, particularly 1.

The plurality of R¹⁰ 's or X's, if any, may be the same or different.

The substituents on R¹⁰ are not specifically limited but may be halogen atoms (e.g., fluorine, chlorine, bromine), hydroxyl groups, mercapto groups, carboxyl groups, epoxy groups, alkyl groups (e.g., methyl, ethyl, i-propyl, propyl, t-butyl), aryl groups (e.g., phenyl, naphthyl), aromatic heterocyclic groups (e.g., furyl, pyrazolyl, pyridyl), alkoxy groups (e.g., methoxy, ethoxy, i-propoxy, hexyloxy), aryloxy groups (e.g., phenoxy), alkenyl groups (e.g., vinyl, 1-propenyl), acyloxy groups (e.g., acetoxy, acryloyloxy, methacryloxy), alkoxycarbonyl groups (e.g., methoxycarbonyl, ethoxycarbonyl), aryloxycarbonyl groups (e.g., phenoxycarbonyl), carbamoyl groups (e.g., carbamoyl, N-methylcarbamoyl, N,N-dimethylcarbamoyl, N-methyl-N-octylcarbamoyl), and acylamino groups (acetylamino, benzoylamino, acrylamino, methacryl amino). These substituents may be further substituted.

At least one of the plurality of R¹⁰ 's, if any, is preferably a substituted or unsubstituted alkyl or aryl group. In particular, an organosilane compound having a vinyl-polymerizable substituent represented by the following formula (4) is preferred.

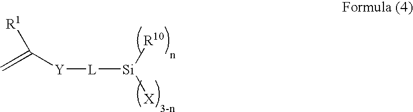

In the formula (4), R¹ represents a hydrogen atom, methyl group, methoxy group, alkoxycarbonyl group, cyano group, fluorine atom or chlorine atom. Examples of the alkoxycarbonyl group include methoxycarbonyl group, and ethoxycarbonyl group. Preferred among these groups are hydrogen atom, methyl group, methoxy group, methoxycarbonyl group, cyano group, fluorine atom, and chlorine atom. More desirable among these groups are hydrogen atom, methyl group, methoxycarbonyl group, fluorine atom, and chlorine atom. Particularly preferred among these groups are hydrogen atom and methyl group.

Y represents a single bond, *—COO—**, *—CONH—** or *—O—**, preferably single bond, *—COO—** or *—CONH—**, more preferably single bond or *—COO—**, particularly *—COO—**. The symbol * indicates the position at which the group is connected to ═C(R¹)—. The symbol ** indicates the position at which the group is connected to L.

L represents a divalent connecting chain. Specific examples of the divalent connecting chain include substituted or unsubstituted alkylene or arylene group, substituted or unsubstituted alkylene group having a connecting group (e.g., ether, ester, amide) therein, and substituted or unsubstituted arylene group having a connecting group therein. Preferred among these divalent connecting chains are substituted or unsubstituted alkylene or arylene group, and substituted or unsubstituted alkylene group having a connecting group therein. More desirable among these divalent connecting chains are unsubstituted alkylene group, unsubstituted arylene group, and substituted or unsubstituted alkylene group having a connecting group therein. Particularly preferred among these divalent connecting chains are unsubstituted alkylene group, and substituted or unsubstituted alkylene group having a connecting group therein. Examples of the substituents on these groups include halogen atoms, hydroxyl groups, mercapto groups, carboxyl groups, epoxy groups, alkyl groups, and aryl groups. These substituents may be further substituted.

The suffix n represents 0 or 1. The plurality of X's, if any, may be the same or different. The suffix n is preferably 0.

R¹⁰ is as defined in the formula (2). R¹⁰ is preferably a substituted or unsubstituted alkyl or aryl group, more preferably unsubstituted alkyl or aryl group.

X is as defined in the formula (2). X is preferably a halogen atom, hydroxyl group or unsubstituted alkoxy group, more preferably chlorine, hydroxyl group or unsubstituted C₁-C₆ alkoxy group, even more preferably hydroxyl group or C₁-C₃ alkoxy group, particularly methoxy group.

Two or more of the compounds of the formulae (3) and (4) may be used in combination. Specific examples of the compounds represented by the formulae (3) and (4) will be given below, but the invention is not limited thereto.

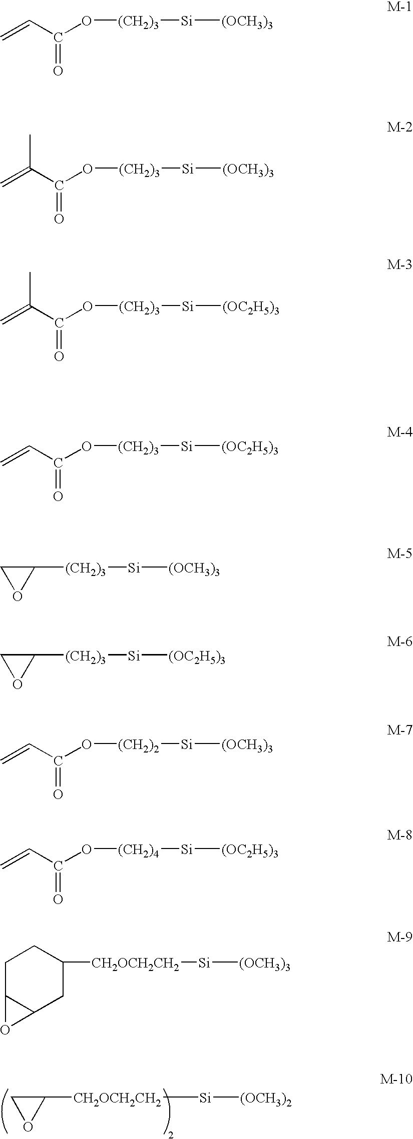

Particularly preferred among these compounds are (M-1), (M-2) and (M-5).

In order to exert the effect of the invention, it is preferred that the hydrolyzate of organosilane and/or partial condensate thereof comprise the aforementioned organosilane having a vinyl polymerizable group incorporated therein. The content of the aforementioned organosilane having a vinyl polymerizable group is preferably from 30% by weight to 100% by weight, more preferably from 50% by weight to 100% by weight, even more preferably from 70% by weight to 95% by weight. When the content of the aforementioned organosilane having a vinyl polymerizable group falls below 30% by weight, there occurs a problem such as production of solid matter, clouding of liquid and deterioration of pot life, making it difficult to control the molecular weight of the product (increase of molecular weight). Further, the insufficient content of polymerizable groups makes it difficult to improve the properties of the product of polymerization (e.g., scratch resistance of anti-reflection layer) to disadvantage. Examples of the aforementioned organosilane having a vinyl polymerizable group include (M-1) and (M-2). Examples of the organosilane free of vinyl polymerizable group include silane compounds having three alkoxy groups such as methyl trimethoxysilane. One of these organosilanes having a vinyl polymerizable group in the above defined amount and one of these organosilane compounds free of vinyl polymerizable group in the above defined range may be used in combination.

The hydrolyzation reaction and condensation reaction of the organosilane are normally effected in the presence of a catalyst. Examples of the catalyst employable herein include inorganic acids such as hydrochloric acid, sulfuric acid and nitric acid, organic acids such as oxalic acid, acetic acid, formic acid, methanesulfonic acid and toluenesulfonic acid, inorganic bases such as sodium hydroxide, potassium hydroxide and ammonia, organic bases such as triethylamine and pyridine, metal alkoxides such as triisopropoxy aluminum and tetrabutoxy zirconium, and metal chelate compounds comprising a metal such as zirconium, titanium and aluminum as a central metal. Preferred among these inorganic acids are hydrochloric acid and sulfuric acid. Preferred among these inorganic acids are those having an acid dissociation constant {pKa value (25° C.)} of 4.5 or less in water. More desirable among these organic acids are hydrochloric acid, sulfuric acid and organic acid having an acid dissociation constant of 3.0 or less in water. Particularly preferred among these organic acids are hydrochloric acid, sulfuric acid and organic acid having an acid dissociation constant of 2.5 or less in water. Even more desirable among these organic acids are those having an acid dissociation constant of 2.5 or less in water. In some detail, methanesulfonic acid, oxalic acid, phthalic acid and malonic acid are more desirable, particularly oxalic acid.

The coating solution of the low refractive index layer to be used in the invention preferably comprises at least any of a β-diketone compound and a β-ketoester compound incorporated therein in addition to at least any of the aforementioned hydrolyzate and partial condensate of organosilane compound and the aforementioned metal chelate compound. This will be further described hereinafter.

In the invention, at least any of β-diketone and β-ketoester compounds represented by the formula R⁴COCH₂COR⁵ is used. These compounds each act as a stability improver for the composition to be used in the invention. In other words, it is thought that the coordination of these compounds to the metal atoms in the aforementioned metal chelate compound (at least any of zirconium, titanium and aluminum compounds) makes it possible to prevent these metal chelate compounds from accelerating the condensation reaction of the sol component of organosilane compound and hence enhance the storage stability of the resulting composition. R⁴ and R⁵ constituting the β-diketone compound and β-ketoester compound are as defined in the aforementioned metal chelate compound.

Specific examples of the β-diketone compound and β-ketoester compound include acetyl acetone, methyl acetoacetate, ethyl acetoacetate, n-propyl acetoacetate, i-propyl acetoacetate, n-butyl acetoacetate, sec-butyl acetoacetate, t-butyl acetoacetate, 2,4-hexane-dione, 2,4-heptane-dione, 3,5-heptane-dione, 2,4-octane-dione, 2,4-nonane-dione, and 5-methyl-hexane-dione. Preferred among these compounds are ethyl acetoacetate and acetyl acetone. Particularly preferred among these compounds is acetyl acetone. These β-diketone compounds and/or β-ketoester compounds may be used singly or in combination of two or more thereof. In the invention, the β-diketone compound and β-ketoester compound are preferably used in an amount of 2 mols or more, more preferably from 3 to 20 mols per mol of metal chelate compound. When the amount of these compounds falls below 2 mols, the resulting composition can exhibit a deteriorated storage stability to disadvantage.

It is preferred that the content of at least any of the aforementioned hydrolyzate and partial condensate of organosilane compound be less in the surface layer having a relatively small thickness but be more in the underlying layer having a relatively great thickness. The content of at least any of the aforementioned hydrolyzate and partial condensate of organosilane compound in the surface layer such as low refractive index layer is preferably from 0.1 to 50% by weight, more preferably from 0.5 to 20% by weight, most preferably from 1 to 10% by weight based on the total solid content in the layer in which these components are incorporated.

The amount of these components to be incorporated in the low refractive index layer is preferably from 0.001 to 50% by weight, more preferably from 0.01 to 20% by weight, even more preferably from 0.05 to 10% by weight, particularly from 0.1 to 5% by weight based on the total solid content in the layer in which these components are incorporated.

In the invention, a composition comprising at least any of the aforementioned hydrolyzate and partial condensate of organosilane compound and a metal chelate compound is firstly prepared. To the composition is then added at least any of a β-diketone compound and a β-ketoester compound. The solution is then incorporated in the coating solution of at least one of hard coat layer and low refractive index layer. The coating solution is then spread.

The content of the sol component of organosilane compound in the low refractive index layer is preferably from 5 to 100% by weight, more preferably from 5 to 40% by weight, even more preferably from 8 to 35% by weight, particularly from 10 to 30% by weight based on the weight of the fluorine-containing polymer from the standpoint of effect, refractive index and film shape and surface conditions.

<Stainproofing Agent, Lubricant>

For the purpose of providing properties such as stainproofness, water resistance, chemical resistance and slipperiness, a known silicone-based or fluorine-based stainproofing agent, a lubricant or the like may be properly added. These additives, if any, are preferably added in an amount of from 0.01 to 20% by weight, more preferably from 0.05 to 10% by weight, particularly from 0.1 to 5% by weight based on the solid content of the low refractive index layer.

Preferred examples of the silicone-based compound include those containing a plurality of dimethyl silyloxy units as repeating units and having substituents at the end of chain and in side chains thereof. The compound chain containing dimethyl silyloxy as repeating unit may contain structural units other than dimethyl silyloxy. The substituents may be the same or different. It is preferred that there be a plurality of substituents. Preferred examples of the substituents include groups containing acryloyl group, methacryloyl group, aryl group, cinnamoyl group, epoxy group, oxetanyl group, hydroxyl group, fluoroalkyl group, polyoxyalkylene group, carboxyl group, amino group, etc. The molecular weight of the silicone-based compound is not specifically limited but is preferably 100,000 or less, particularly 50,000 or less, most preferably from 3,000 to 30,000. The content of silicon atoms in the silicone-based compound, too, is not specifically limited but is preferably 18.0% by weight or more, particularly from 25.0 to 37.8% by weight, most preferably from 30.0 to 37.0% by weight. Preferred examples of the silicone-based compound include X-22-174DX, X-22-2426, X-22-164B, X22-164C, X-22-170DX. X-22-176D and X-22-1821 (produced by Shin-Etsu Chemical Co., Ltd.), FM-0725, FM-7725, FM-4421, FM-5521, FM-6621 and FM-1121 (produced by Chisso Corporation), and DMS-U22, RMS-033, RMS-083, UMS-182, DMS-H21, DMS-H31, HMS-301, FMS121, FMS123, FMS131, FMS141 and FMS221 (produced by Gelest, Inc.). However, the invention is not limited to these products.

As the fluorine-based compound there is preferably used a compound having a fluoroalkyl group. The fluoroalkyl group preferably has from 1 to 20 carbon atoms, more preferably from 1 to 10 carbon atoms, and may have a straight-chain structure (e.g., —CF₂CH₃, —CH₂(CF₂)₄, —CH₂(CF₂)₈CF₃, —CH₂CH₂(CF₂)₄H), a branched structure (e.g., —CH(CF₃)₂, —CH₂CF(CF₃)₂, —CH(CH₃)CF₂CF₃, —CH(CH₃)(CF₂)₅CF₂H) or an alicyclic structure (preferably 5-membered or 6-membered ring such as perfluorocyclohexyl group, perfluorocyclopentyl group or alkyl group substituted thereby). The fluoroalkyl group may have an ether bond (e.g., —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H). A plurality of the fluoroalkyl groups may be incorporated in the same molecule.

The fluorine-based compound preferably further contains substituents contributing to the formation of bond to the low refractive index layer or the compatibility with the low refractive index layer. These substituents may be the same or different. It is preferred that there be a plurality of these substituents. Preferred examples of these substituents include acryloyl group, methacryloyl group, vinyl group, aryl group, cinnamonyl group, epoxy group, oxetanyl group, hydroxyl group, polyoxyalkylene group, carboxyl group, and amino group. The fluorine-based compound may be used in the form of polymer or oligomer with a fluorine-free compound. The fluorine-based compound may be used without any limitation on the molecular weight. The content of fluorine atoms in the fluorine-based compound is not specifically limited but is preferably 20% by weight or more, particularly from 30 to 70% by weight, most preferably from 40 to 70% by weight. Preferred examples of the fluorine-based compound include R-2020, M-2020, R3833 and M-3833 (produced by DAIKIN INDUSTRIES, Ltd.), and Megafac F-171, Megafac F-172 and Megafac F-179A, Diffenser MCF-300 (produced by DAINIPPON INK AND CHEMICALS, INCORPORATED). However, the invention is not limited to these products.

<Dustproofing Agent, Antistatic Agent>

For the purpose of providing properties such as dustproofing properties and antistatic properties, a dustproofing agent such as known cationic surfactant and polyoxyalkylene-based compound, antistatic agent or the like may be properly added. Referring to these dustproofing agents and antistatic agents, the aforementioned silicone-based compound or fluorine-based compound may have its structural unit to act partly to perform such a performance. These additives, if any, are preferably added in an amount of from 0.01 to 20% by weight, more preferably from 0.05 to 10% by weight, particularly from 0.1 to 5% by weight based on the total solid content of the low refractive index layer-forming composition. Preferred examples of these compounds include Megafac F-150 (produced by DAINIPPON INK AND CHEMICALS, INCORPORATED), and SH-3748 (produced by Toray Dow Corning Co., Ltd.). However, the invention is not limited to these products.

<Polymerization Initiator>

Examples of the polymerization initiator which generates radicals when irradiated with ionized radiation include acetophenones, benzoins, benzophenones, phosphine oxides, ketals, anthraquinones, thioxanthones, azo compounds, peroxides, 2,3-dialkyl dione compounds, disulfide compounds, fluoroamine compounds, and aromatic sulfoniums. Examples of the acetophenones include 2,2-diethoxyacetophenone, p-dimethylacetophenone, 1-hydroxydimethylphenylketone, 1-hydroxycyclohexylphenylketone, 2-methyl-4-methylthio-2-morpholinopropiophenone, and 2-benzyl-2-dimethylamino-1-(4-morpholinophenyl)-butanone. Examples of the benzoins include benzoinbenzenesulfonic acid ester, benzointoluenesulfonic acid ester, benzoinmethyl ether, benzoinethyl ether, and benzoin isopropyl ether. Examples of the benzophenones include benzophenone, 2,4-dichlorobenzophenone, 4,4-dichloro benzophenone, and p-chlorobenzophenone. Examples of the phosphine oxides include 2,4,6-trimethylbenzoin diphenyl phosphine oxide.

Various examples of polymerization initiator are disclosed also in Kazuhiro Takahashi, “Saishin UV Kouka Gijutsu (Modern UV Curing Technique)”, page 159, Technical Information Institute Co., Ltd., 1991. These polymerization initiators are useful in the invention.

Preferred examples of commercially available ionized radiation-cleavable ionized radiation radical polymerization initiators include “Irgacure 651, 184, 907” (produced by Ciba Specialty Chemicals Inc.).

The ionized radiation polymerization initiator is preferably used in an amount of from 0.1 to 15 parts by weight, more preferably from 1 to 10 parts by weight based on 100 parts by weight of the polyfunctional monomer.

In addition to the ionized radiation polymerization initiator, a photosensitizer may be used. Specific examples of the photosensitizer include n-butylamine, triethylamine, tri-n-butylphosphine, Michler's ketone, and thioxanthone.

As the heat radical polymerization initiator there may be used an organic or inorganic peroxide, an organic azo or diazo compound or the like.

Specific examples of the organic peroxide include benzoyl peroxide, halogen benzoyl peroxide, lauroyl peroxide, acetyl peroxide, dibutyl peroxide, cumene hydroperoxide, and butyl hydroperoxide. Specific examples of the inorganic peroxide include hydrogen peroxide, ammonium persulfate, and potassium persulfate. Specific examples of the azo compound include 2,2′-azobis(isobutylnitrile), 2,2′-azobis (propionitrile), and 1,1′-azobis(cyclohexanedinitrile). Specific examples of the diazo compound include diazoaminobenzene, and p-nitrobenzene diazonium.

In another preferred embodiment, the low refractive index layer in the anti-reflection film of the invention is a cured layer formed by spreading and curing a curable composition comprising at least any of a hydrolyzate of a compound represented by the following formula (5) and a partial condensate thereof. In this case, the refractive index of the low refractive index layer is preferably from 1.30 to 1.55.
(R²)ₙ—Si(Y)₄₋ₙ (5)
wherein R² represents a substituted or unsubstituted alkyl group, partly or fully fluorine-substituted alkyl group or substituted or unsubstituted aryl group; Y represents a hydroxyl group or hydrolyzable group; and n represents an integer of from 0 to 3.

In some detail, R² represents a C₁-C₃₀ alkyl group, C₁-C₃₀ partly or fully fluorine-substituted alkyl group or C₆-C₃₀ substituted or unsubstituted aryl group. The partly fluorine-substituted alkyl group, if any, may have substituents other than fluorine atom. Examples of the substituents on these groups include those listed as substituents with reference to the group represented by R¹⁰ in the formula (3) described later. Examples of the hydrolyzable group represented by Y include halogen atoms (e.g., chlorine, bromine), C₁-C₅ alkoxy groups (e.g., methoxy, ethoxy, propoxy, butoxy), and C₁-C₅ acyloxy groups (e.g., acetoxy, propanoyloxy). Particularly preferred among these hydrolyzable groups are methoxy group and ethoxy group. R² is preferably a partly or fully fluorine-substituted alkyl group. Specific examples of the compound represented by the formula (2) include CF₃(CH₂)₂Si(OCH₃)₃, CF₃CF₂(CH₂)₂Si(OCH₃)₃, CF₃(CH₂)₂(CH₂)₂Si(OCH₃)₃, CF₃(CF₂)₃(CH₂)₂Si(OCH₃)₃, CF₃(CF₂)₄(CH₂)₂Si(OCH₃)₃, CF₃(CF₂)₅(CH₂)₂Si(OCH₃)₃, CF₃(CF₂)₆(CH₂)₂Si(OCH₃)₃, CF₃(CF₂)₇(CH₂)₂Si(OCH₃)₃, CF₃(CF₂)₈(CH₂)₂Si(OCH₃)₃, CF₃(CF₂)₉(CH₂)₂Si(OCH₃)₃, CF₃(CH₂)₂Si(OC₂H₅)₃, CF₃CF₂(CH₂)₂Si(OC₂H₅)₃, CF₃(CF₂)₂(CH₂)₂Si(OC₂H₅)₃, CF₃(CF₂)₃(CH₂)₂Si(OC₂H₅)₃, CF₃(CF₂)₄(CH₂)₂Si(OC₂H₅)₃, CF₃(CF₂)₅(CH₂)₂Si(OC₂H₅)₃, CF₃(CF₂)₆(CH₂)₂Si(OC₂H₅)₃, CF₃(CF₂)₇(CH₂)₂Si(OC₂H₅)₃, CF₃(CF₂)₈(CH₂)₂Si(OC₂H₅)₃, and CF₃(CF₂)₉(CH₂)₂Si(OC₂H₅)₃. Particularly preferred among these compounds are CF₃(CF₂)₇(CH₂)₂Si(OCH₃)₃ and CF₃(CF₂)₇(CH₂)₂Si(OC₂H₅)₃. For the hydrolyzation or dehydration condensation of these compounds, a method described with reference to the compounds represented by the formulae (3) and (4) may be used.

<Solvent>

As the solvent to be used in the coating composition for forming the low refractive index layer of the invention there may be used any solvent selected from the standpoint of capability of dissolving or dispersing the various components therein, ease of forming uniform surface conditions at the coating step and drying step, assurance of liquid preservability, provision of proper saturated vapor pressure. From the standpoint of burden of drying, the solvent to be used herein preferably comprises a solvent having a boiling point of 100° C. or less at ordinary pressure and room temperature as a main component and a small amount of a solvent having a boiling point of 100° C. or more for the purpose of adjusting the drying speed.

Examples of the solvent having a boiling point of 100° C. or less include hydrocarbons such as hexane (boiling point: 68.7° C.), heptane (boiling point: 98.4° C.), cyclohexane (boiling point: 80.7° C.) and benzene (boiling point: 80.1° C.), halogenated hydrocarbons such as dichloromethane (boiling point: 39.8° C.), chloroform (boiling point: 61.2° C.), carbon tetrachloride (boiling point: 76.8° C.), 1,2-dichloroethane (boiling point: 83.5° C.) and trichloroethylene (boiling point: 87.2° C.), ethers such as diethylether (boiling point: 34.6° C.), diisopropylether (boiling point: 68.5° C.), dipropylether (boiling point: 90.5° C.) and tetrahydrofurane (boiling point: 66° C.), esters such as ethyl formate (boiling point: 54.2° C.), methyl acetate (boiling point: 57.8° C.), ethyl acetate (boiling point: 77.1° C.) and isopropyl acetate (boiling point: 89° C.), ketones such as acetone (boiling point: 56.1° C.) and 2-butanone (also referred to as “2-butanone; boiling point: 79.6° C.), alcohols such as methanol (boiling point: 64.5° C.), ethanol (boiling point: 78.3° C.), 2-propanol (boiling point: 82.4° C.) and 1-propanol (boiling point: 97.2° C.), cyano compounds such as acetonitrile (boiling point: 81.6° C.) and propionitrile (boiling point: 97.4° C.), and carbon disulfide (boiling point: 46.2° C.). Preferred among these solvents are ketones and esters. Particularly preferred among these solvents are ketones. Particularly preferred among the ketones is 2-butanone.

Examples of the solvent having a boiling point of 100 C or more include octane (boiling point: 125° C.), toluene (boiling point: 110.6° C.), xylene (boiling point: 138° C.), tetrachloroethylene (boiling point: 121.2° C.), chlorobenzene (boiling point: 131.7° C.), dioxane (boiling point: 101.3° C.), dibutylether (boiling point: 142.4° C.), isobutyl acetate (boiling point: 118° C.), cyclohexanone (boiling point: 155.7° C.), 2-methyl-4-pentanone (also referred to as “MIBK”; boiling point: 115.9° C.), 1-butanol (boiling point: 117.7° C.), N,N-dimethylformamide (boiling point: 153° C.), N,N-dimethylacetamide (boiling point: 166° C.), and dimethylsulfoxide (boiling point: 189° C.). Preferred among these solvents are cyclohexanone and 2-methyl-4-pentanone.

(High Refractive Index Layer, Middle Refractive Index Layer)

The anti-reflection film of the invention may comprise a high refractive index layer or a middle refractive index layer provided therein to provide better anti-reflection properties.

The refractive index of the high refractive index layer falls within the range of from 1.55 to 2.40. When there is a layer having a refractive index falling within this range, it means that there is present a high refractive index layer of the invention. The above defined range of refractive index is that of the refractive index of the so-called high refractive index layer or middle refractive index layer. These layers will be occasionally generically referred to as “high refractive index layer” hereinafter.

When there are present a high refractive index layer and a low refractive index layer in admixture, the layer having a higher refractive index than that of the hard coat layer or middle refractive index layer is referred to as “high refractive index layer”. The layer having a higher refractive index than that of the support, hard coat layer and middle refractive index layer and a lower refractive index than that of the high refractive index layer is referred to as “middle refractive index layer”. The refractive index of these layers can be properly adjusted by adjusting the amount of the particulate inorganic material or binder to be added.

The refractive index of the middle refractive index layer in the anti-reflection film of the invention is from 1.55 to 1.85, preferably from 1.60 to 1.75.

The refractive index of the high refractive index layer in the anti-reflection film of the invention is from 1.65 to 2.20, preferably from 1.80 to 1.95.

From the standpoint of reduction of reflectance, the middle refractive index layer preferably satisfies the following numerical relationship (II) and the high refractive index layer preferably satisfies the following numerical relationship (III).
(l/4)×0.7<n2×d2<(l/4)×1.3 (II)
(p/4)×0.7<n3×d3<(p/4)×1.3 (III)
wherein p represents 1 or 2; n3 represent the refractive index of the high refractive index layer; and d3 represents the thickness (nm) of the high refractive index layer. λ indicates wavelength falling within a range of from 500 to 550 nm.

The satisfaction of the aforementioned numerical relationships (II) and (III) means that there are present l and p satisfying the numerical relationships (II) and (III), respectively, in the above defined wavelength range.

<Particulate Inorganic Material Comprising Titanium Dioxide as a Main Component>

The aforementioned high refractive index layer comprises a particulate inorganic material comprising titanium dioxide as a main component containing at least one element selected from the group consisting of cobalt, aluminum and zirconium. The term “main component” as used herein is meant to indicate the component having the highest content (% by weight) in the components constituting the particle.

The refractive index of the particulate inorganic material mainly composed of titanium dioxide of the invention is preferably from 1.90 to 2.80, most preferably from 2.20 to 2.80. The weight-average diameter of the primary particle is preferably from 1 to 200 nm, more preferably from 2 to 100 nm, particularly from 2 to 80 nm.

The incorporation of at least one element selected from the group consisting of cobalt, aluminum and zirconium in the particulate inorganic material mainly composed of titanium dioxide makes it possible to inhibit the photocatalytic activity of titanium dioxide and hence improve the weathering resistance of the high refractive index layer.

The particulate inorganic material main composed of titanium dioxide to be used in the invention may be subjected to surface treatment. For the surface treatment, an inorganic compound containing cobalt, an inorganic compound such as Al(OH)₃ and Zr(OH)₄ or an organic compound such as silane coupling agent is used. The particulate inorganic material mainly composed of titanium dioxide of the invention may have a core/shell structure developed by surface treatment as disclosed in JP-A-2001-166104.

The shape of the particulate inorganic material mainly composed of titanium dioxide to be incorporated in the high refractive index layer is preferably grain, sphere, cube, spindle or amorphous, particularly amorphous or spindle.

<Dispersant>

For the dispersion of the aforementioned particulate inorganic material, a dispersant may be used. In particular, a dispersant having an anionic group is preferred.

As the anionic group there may be effectively used a group having an acidic proton such as carboxyl group, sulfonic acid group (and sulfo group), phosphoric acid group (and phosphono group) and sulfonamide group or salt thereof. Preferred among these anionic groups are carboxyl group, sulfonic acid group, phosphoric acid group and salt thereof, particularly carboxyl group and phosphoric acid group. The number of anionic groups per molecule of dispersant may be 1 or more, preferably 2 or more, more preferably 5 or more, particularly 10 or more on the average. A plurality of anionic groups may be incorporated per molecule. The dispersant preferably contains a crosslinkable or polymerizable functional group.

<High Refractive Index Layer and Forming Method Thereof>

The particulate inorganic material mainly composed of titanium dioxide to be used in the high refractive index layer is used in the form of dispersion to form the high refractive index layer.

The particulate inorganic material is dispersed in a dispersion medium in the presence of the aforementioned dispersant.

As the dispersion medium there is preferably used a liquid having a boiling point of from 60° C. to 170° C. Examples of the dispersion medium include water, alcohol, ketone, ester, aliphatic hydrocarbon, halogenated hydrocarbon, aromatic hydrocarbon, amide, ether, and ether alcohol. Preferred among these dispersion media are toluene, xylene, methyl ethyl ketone, methyl isobutyl ketone, cyclohexanone, and butanol.

Particularly preferred among these dispersion media are methyl ethyl ketone, methyl isobutyl ketone, and cyclohexanone.

The particulate inorganic material is subjected to dispersion using a dispersing machine. Examples of the dispersing machine employable herein include sand grinder mill (e.g., bead mill with pin), high speed impellor mill, pebble mill, roller mill, attritor, and colloid mill. Particularly preferred among these dispersing machines are sand grinder mill and high speed impellor mill. The particulate inorganic material may be subjected to previous dispersion. Examples of the dispersing machine to be used in previous dispersion include ball mill, three-roll mill, kneader, and extruder.

The particulate inorganic material dispersion preferably stays finely divided in the dispersion medium as much as possible. The weight-average particle diameter of the particulate inorganic material is from 1 to 200 nm, preferably from 5 to 150 nm, more preferably from 10 to 100 nm, particularly from 10 to 80 nm.

The fine division of the particulate inorganic material to 200 nm or less makes it possible to form a high refractive index layer which is not subject to loss of transparency.

The high refractive index layer to be used in the invention is preferably formed by adding a binder precursor required to form a matrix (ionized radiation-curing compound, etc.), a photopolymerization initiator or the like to a dispersion having a particulate inorganic material dispersed in a dispersion medium as previously mentioned to obtain a high refractive index layer-forming coating composition, spreading the high refractive index layer-forming coating composition over a transparent support, and then subjecting the ionized radiation-curing compound (e.g., polyfunctional monomer or oligomer) to crosslinking reaction or polymerization reaction to cause curing of the coating composition.

The polymerization reaction of the photopolymerizable polyfunctional monomer is preferably effected in the presence of a photopolymerization initiator. As the photopolymerization initiator there is preferably used a photoradical polymerization initiator or photocation polymerization initiator, particularly photocation polymerization initiator. As the photoradical polymerization initiator there may be used the same material as mentioned above with reference to hard coat layer.

The binder to be incorporated in the high refractive index layer preferably further has a silanol group. When the binder further has a silanol group, the physical strength, chemical resistance and weathering resistance of the high refractive index layer can be further improved.

The silanol group can be incorporated in the binder by adding a compound having a crosslinkable or polymerizable functional group to the aforementioned high refractive index layer-forming coating composition, spreading the coating composition over a transparent support, and then subjecting the aforementioned dispersant or polyfunctional monomer or oligomer to crosslinking reaction or polymerization reaction.

The binder in the high refractive index layer preferably has an amino group or quaternary ammonium group. The monomer having an amino group or quaternary ammonium group keeps the particulate inorganic material well dispersed in the high refractive index layer, making it possible to prepare a high refractive index layer excellent in physical strength, chemical resistance and weathering resistance.

In the structure of the crosslinked or polymerized binder, the main chain of the polymer is crosslinked or polymerized. Examples of the polymer chain include polyolefins (saturated hydrocarbon), polyethers, polyureas, polyurethanes, polyesters, polyamines, polyamides, and melamine resins. Preferred among these polymer chains are polyolefin main chain, polyether main chain and polyurea main chain. More desirable among these polymer chains are polyolefin main chain and polyether main chain. Most desirable among these polymer chains is polyolefin main chain.

The binder is preferably a copolymer having a repeating unit having an anionic group and a repeating unit having a crosslinked or polymerized structure. The proportion of the repeating unit having an anionic group is preferably from 2 to 96 mol-%, more preferably from 4 to 94 mol-%, most preferably from 6 to 92 mol-%. The repeating unit may have two or more anionic groups. The proportion of the repeating unit having a crosslinked or polymerized structure in the copolymer is preferably from 4 to 98 mol-%, more preferably from 6 to 96 mol-%, most preferably from 8 to 94 mol-%.

The high refractive index layer may comprise a finely particulate material incorporated therein besides the aforementioned particulate inorganic material mainly composed of titanium dioxide.

The content of the particulate inorganic material in the high refractive index layer is preferably from 10 to 90% by weight, more preferably from 15 to 80% by weight, particularly from 15 to 75% by weight based on the weight of the high refractive index layer. Two or more particulate inorganic materials may be incorporated in combination in the high refractive index layer.

In the case where the low refractive index layer is provided on the high refractive index layer, the refractive index of the high refractive index layer is preferably higher than that of the transparent support.

The high refractive index layer is also preferably made of a binder obtained by the crosslinking or polymerization reaction of an ionized radiation-curing compound containing an aromatic ring, an ionized radiation-curing compound containing a halogen element other than fluorine (e.g., Br, I, Cl), an ionized radiation-curing compound containing an element such as sulfur, nitrogen and phosphorus or the like.

In order to prepare an anti-reflection film by forming a low refractive index layer on a high refractive index layer, the refractive index of the high refractive index layer is preferably from 1.55 to 2.40, more preferably from 1.60 to 2.20, even more preferably from 1.65 to 2.10, most preferably from 1.80 to 2.00.

The high refractive index layer may comprise a resin, a surfactant, an antistatic agent, a coupling agent, a thickening agent, a coloration inhibitor, a colorant (e.g., pigment, dye), an anti-glare particulate material, an ant-foaming agent, a leveling agent, a fire retardant, an ultraviolet absorber, an infrared absorber, an adhesion-providing agent, a polymerization inhibitor, an oxidation inhibitor, a surface modifier, an electrically-conductive particulate metal, etc. incorporated therein besides the aforementioned components (e.g., particulate inorganic material, polymerization initiator, photosensitizer).

The thickness of the high refractive index layer may be properly designed. In the case where the high refractive index layer is used as an optical interference layer as described later, the thickness of the high refractive index layer is preferably from 30 to 200 nm, more preferably from 50 to 170 nm, particularly from 60 to 150 nm.

In order to form the high refractive index layer, the crosslinking reaction or polymerization reaction of the ionized radiation-curable compound is preferably effected in an atmosphere having an oxygen concentration of 10 vol-% or less, more preferably 6 vol-% or less, particularly 2 vol-% or less, most preferably 1 vol-% or less.

(Transparent Support)

As the transparent support of the anti-reflection film of the invention there is preferably used a plastic film. Examples of the polymer constituting the plastic film include cellulose esters (e.g., triacetyl cellulose, diacetyl cellulose, typically TAC-TD80U, TD80UF, produced by Fuji Photo Film Co., Ltd.), polyamides, polycarbonates, polyesters (e.g., polyethylene terephthalate, polyethylene naphthalate), polystyrenes, polyolefins, norbornene-based resins (e.g., Arton: trade name, produced by JSR), and amorphous polyolefins (e.g., Zeonex: trade name, produced by ZEON CORPORATION). Preferred among these polymers are triacetyl cellulose, polyethylene terephthalate, norbornene-based resins, and amorphous polyolefins. Particularly preferred among these polymers is triacetyl cellulose.

A triacetyl cellulose film is composed of a single layer or a plurality of layers. The single-layer triacetyl cellulose film is formed by drum casting method disclosed in JP-A-7-11055, band casting method or the like. The latter triacetyl cellulose film composed of a plurality of layers is formed by a so-called cocasting method disclosed in JP-A-61-94725 and JP-B-62-43846. In some detail, the cocasting method comprises dissolving a raw material flake in a solvent such as halogenated hydrocarbon (e.g., dichloromethane), alcohol (e.g., methanol, ethanol, butanol), ester (e.g., methyl formate, methyl acetate) and ether (e.g., dioxane, dioxolane, diethyl ether), optionally adding various additives such as plasticizer, ultraviolet absorber, deterioration inhibitor, lubricant and exfoliation accelerator to the solution to prepare a solution (referred to as “dope”), casting the dope over a support composed of a horizontal endless metallic belt or a rotary drum in a single layer if a single-layer film is formed or simultaneously in a plurality of layers comprising a low concentration dope on the both sides of a high concentration cellulose ester dope if a multi-layer film is formed, drying the cast on the support to some extent, peeling the film thus provided with rigidity off the support, and then passing the film through a drying zone by various conveying means to remove the solvent therefrom.

Representative examples of the aforementioned solvent for dissolving triacetyl cellulose include dichloromethane. However, the solvent is preferably substantially free of halogenated hydrocarbon such as dichloromethane from the standpoint of global environment or working atmosphere. The term “substantially free of halogenated hydrocarbon” as used herein is meant to indicate that the proportion of halogenated hydrocarbon in the organic solvent is less than 5% by weight (preferably less than 2% by weight).

For the details of the aforementioned various cellulose acetate films (film made of triacetyl cellulose) and method of preparing thereof, reference can be made to Japan Institute of Invention and Innovation's Kokai Giho No. 2001-1745, issued on Mar. 15, 2001.

The thickness of the cellulose acetate film is preferably from 40 μm to 120 μm. Taking into account handleability, coatability, etc., the thickness of the cellulose acetate film is preferably about 80 μm. However, from the standpoint of tendency toward the reduction of the thickness of polarizing plate accompanying the recent demand for the reduction of the thickness of displays, the thickness of the cellulose acetate film is preferably from about 40 μm to 60 μm. In the case where such a thin cellulose acetate film is used as a transparent support for the anti-reflection film of the invention, it is desirable that the aforementioned problems with handleability, coatability, etc. be solved by optimizing the solvent to be incorporated in the coating solution to be directly spread over the cellulose acetate film, the thickness of the coat layer, the percent crosslink shrinkage of the coat layer, etc.

<Other Layers>

Examples of other layers which may be provided interposed between the transparent support and the hard coat layer of the invention include antistatic layer (to be provided in the case where there are requirements that the surface resistivity on the display side be reduced or in the case where the attachment of dust to the surface raises a problem), moistureproof layer, adhesion improving layer, and rainbow (interference) preventive layer.

These layers can be formed by known methods.

The anti-reflection film of the invention can be formed by the following method, but the invention is not limited thereto.

(Preparation of Coating Solution)

Firstly, a coating solution containing components constituting the various layers is prepared. During this procedure, the rise of the water content in the coating solution can be inhibited by minimizing the evaporation loss of the solvent. The water content in the coating solution is preferably 5% or less, more preferably 2% or less. The inhibition of the evaporation loss of the solvent is accomplished by improving the airtightness of the tank during the agitation of the various materials which have been put therein or minimizing the contact area of the coating solution with respect to air during the movement of the coating solution. Alternatively, a unit of reducing the water content in the coating solution may be provided during or before and after spreading.

The coating solution for forming the hard coat layer, etc. are preferably filtered such that foreign matters having a size corresponding to the dry thickness (about 50 nm to 120 nm) of the layer to be formed directly on these layers (e.g., low refractive index layer, middle refractive index layer) can be removed substantially completely (90% or more). Since the light-transmitting particulate material for providing light diffusivity has a thickness equal to or greater than that of the low refractive index layer or middle refractive index layer, the aforementioned filtration is preferably conducted on the intermediate solution comprising all materials other than light-transmitting particulate material incorporated therein. In the case where no filters which can remove the aforementioned foreign matters having a small particle diameter are available, filtration is preferably conducted such that foreign matters having a size corresponding to the wet thickness (about from 1 to 10 μm) of the layer to be directly formed on these layers can be removed substantially completely. In these manners, point defects of the layer formed directly on these layers can be eliminated.

(Coating/Drying)

Subsequently, the coating solution for forming the layers to be formed directly on the support, e.g., hard coat layer is coated (or spread) over a transparent support by a dip coating method, air knife coating method, curtain coating method, roller coating method, wire bar coating method, gravure coating method, microgravure coating method or extrusion coating method (see U.S. Pat. No. 2,681,294), and then heated and dried. Thereafter, the coat layer is irradiated with light rays or heated to undergo curing. In this manner, a hard coat layer, etc. are formed.

If necessary, the hard coat layer may be composed of a plurality of layers.

Subsequently, the coating solution for forming the low refractive index layer is coated over the hard coat layer in the same manner as mentioned above, dried to remove the solvent, and then cured by at least any of irradiation with light rays and heating to form a low refractive index layer. In this manner, an anti-reflection film of the invention is obtained.

In order to form the hard coat layer, the aforementioned coating solution is preferably coated over the substrate film to a wet thickness of from 6 to 30 μm directly or with other layers interposed therebetween. As the coating method there is preferably used a reverse roll coating method involving microgravure coating.

In order to form the low refractive index layer, middle refractive index layer and high refractive index layer, the coating composition is preferably spread over the hard coat layer to a wet thickness of from 1 to 10 μm, more preferably from 2 to 5 μm, directly or with other layers interposed therebetween.

The hard coat layer coating solution and the low refractive index layer coating solution are spread over the substrate film directly or with other layers interposed therebetween. The substrate film is then conveyed into a heated zone so that it is dried to evaporate the solvent. During this procedure, the temperature of the drying zone is preferably from 25° C. to 140° C. It is also preferred that the former half of the drying zone have a relative low temperature and the latter half of the drying zone have a relatively high temperature. However, these temperatures are preferably not higher than the value at which the components other than the solvents contained in the various layer coating compositions begin to evaporate. For example, among commercially available photoradical generators to be used in combination with the ultraviolet-curing resin are those which evaporate approximately several tens of percentage points in 120° C. hot air in several minutes. Further, some monofunctional or bifunctional acrylate monomers evaporate in 100° C. hot air. In this case, the temperature of the drying zone is preferably not higher than the value at which the components other than the solvents contained in the various layer coating compositions begin to evaporate as mentioned above.

Further, the drying air to be blown onto the substrate film having the various layer coating compositions spread thereover preferably flows over the surface of the coat layer at a velocity of from 0.1 to 2 m/sec when the solid content concentration of the aforementioned coating compositions falls within the range of from 1 to 50% to prevent the occurrence of unevenness in drying.

When the temperature difference between the conveying roll in contact with the side of the substrate film having the various layer coating compositions spread thereover opposite the coated side and the substrate film in the drying zone is predetermined to be from 0° C. to 20° C., the occurrence of unevenness in drying due to unevenness in heat conduction over the conveying roll can be prevented to advantage.

In order to inhibit the interference unevenness in the hard coat layer, it is preferred that the rate at the solvent is dried be controlled to 0.3 g/m² or more, preferably 0.4 g/m² or more, more preferably 0.5 g/m² or more.

In order to raise the drying rate, drying is preferably effected with drying air. In this case, the wind velocity of drying air is preferably 1 m/sec or more, more preferably 2 m/sec or more, even more preferably 3 n/sec or more.

(Curing)

The method of curing the hard coat layer and the low refractive index layer of the invention and the middle refractive index layer and the high refractive index layer to be formed as necessary will be described hereinafter.

The hard coat layer and the low refractive index layer of the invention and the middle refractive index layer and the high refractive index layer to be formed as necessary are formed by passing the coat layers on the web through zones for curing the coat layers by a method involving at least any of irradiation with ionized radiation and heating after the solvent drying zone. For example, in the case where the coat layers are cured by irradiation with ultraviolet rays, these coat layers are preferably irradiated with ultraviolet rays from an ultraviolet lamp at a dose of from 10 mJ/cm² to 1,000 mJ/cm². During this procedure, the distribution of dose over the range between the two ends in the crosswise direction of web preferably shows a proportion of from 50% to 100%, more preferably from 80% to 100% based on the central maximum dose. The term “ionized radiation” as used herein has a normally used meaning and indicates a radiation which causes excitation or ionization when transmitted by a material, i.e., particle beam and electromagnetic wave also singly called radiation, e.g., alpha rays, beta rays, gamma rays, high energy particle beam, neutron radiation, electron ray, light beam (ultraviolet rays and visible light). Ionized radiations which are particularly preferred in the invention are ultraviolet rays and visible light.

The oxygen concentration during curing is preferably 15 vol-% or less, more preferably 1 vol-% or less, even more preferably 0.3 vol-% or less. When the oxygen concentration during curing is more than 15 vol-%, the deactivation of radical by oxygen becomes remarkable for the reason that the thickness of the various layers of the invention which have been dried to remove the solvent is as thin as from 0.1 μm to scores of micrometers (great surface area per volume), resulting in the fatal deterioration of the scratch resistance of the cured layer, that is, scratch resistance described later, and the partial swelling or dissolution of the surface of the cured layer followed by interfacial mixing that deteriorates reflecting properties.

In order to control the oxygen concentration during curing as mentioned above, the air is preferably purged with nitrogen gas or the like to reduce the oxygen concentration.

In the case where the percent curing (100-content of functional group residue) of the hard coat layer is a value of less than 100%, when the percent curing of the hard coat layer after the curing of a low refractive index layer of the invention thereon by any of irradiation with ionized radiation and application of heat is higher than that developed before the provision of the low refractive index layer, the adhesion between the hard coat layer and the low refractive index layer can be improved to advantage.

The anti-reflection film of the invention thus produced can be used to prepare a polarizing plate which is then used in a liquid crystal display. In this case, the polarizing plate is disposed on the outermost surface of the display with an adhesive layer provided on one side thereof. The anti-reflection film of the invention is preferably used as at least one of two sheets of protective film between which the polarizing film in the polarizing plate is interposed. The anti-reflection film of the invention can also act as a protective film to reduce the production cost of the polarizing plate. Further, the anti-reflection film of the invention can be used as an outermost layer to prevent the reflection of external light rays, etc., making it possible to provide a polarizing plate excellent also in scratch resistance, stainproofness, etc.

In order to use the anti-reflection film of the invention as one of two sheets of surface protective film for polarizing plate to prepare a polarizing plate, the anti-reflection film is preferably subjected to hydrophilicization on the side of the transparent support opposite the anti-reflection structure, i.e., on the side thereof where it is stuck to the polarizing film to improve the adhesion of the adherend surface thereof

(Saponification)

(1) Alkaline Solution Dipping Method

This is a method which comprises dipping the anti-reflection film in an alkaline solution under proper conditions to saponify the entire surface of the film having reactivity with alkali. This method is advantageous in cost because it requires no special facilities. On the other hand, this method cannot be applied to the case where the anti-reflection film comprises a layer having a low alkali resistance such as sol-gel low refractive index layer. The alkaline solution is preferably an aqueous solution of sodium hydroxide. The concentration of the alkaline solution is preferably from 0.5 to 3 mol/l, particularly from 1 to 2 mol/l. The temperature of the alkaline solution is preferably from 30° C. to 75° C., particularly from 40° C. to 60° C.

The aforementioned combination of saponifying conditions is preferably a combination of relatively mild conditions but can be predetermined by the material and configuration of the anti-reflection film and the target contact angle.

It is preferred that the anti-reflection film which has been dipped in the alkaline solution be thoroughly washed with water or dipped in a dilute acid to neutralize the alkaline component so that the alkaline component is not left in the film.

When the anti-reflection film is saponified, the transparent support is hydrophilicized on the side thereof opposite the anti-reflection layer. The protective film for polarizing plate is used in such an arrangement that the hydrophilicized surface of the transparent support comes in contact with the polarizing film.

The hydrophilicized surface of the transparent support is effective for the improvement of the adhesion to the adhesive layer mainly composed of polyvinyl alcohol.

Referring to saponification, the contact angle of the surface of the transparent support on the side thereof opposite the anti-reflection layer with respect to water is preferably as small as possible from the standpoint of adhesion to the polarizing film. On the other hand, since the dipping method is subject to damage by alkali even on the surface of the transparent support on the anti-reflection layer side thereof, it is important to use minimum required reaction conditions. In the case where as an index of damage of anti-reflection layer by alkali there is used the contact angle of the surface of the transparent support on the side thereof opposite the anti-reflection layer, i.e., on the side on which it is stuck to the polarizing film of the anti-reflection film with respect to water, the contact angle is preferably from 10° to 50°, more preferably from 30° to 50°, even more preferably from 40° to 50°, if the support is a triacetyl cellulose film in particular. When the contact angle falls within the above defined range, the resulting anti-reflection layer exhibits a sufficient adhesion to the polarizing film and undergoes little damage.

(2) Alkaline Solution Coating Method

As a method of avoiding the damage of the anti-reflection layer in the aforementioned dipping method there is preferably used an alkaline solution coating method which comprises spreading an alkaline solution only over the surface of the transparent support on the side thereof opposite the anti-reflection layer, and heating, rinsing and drying the coat layer under proper conditions. The term “spreading” as used herein is meant to indicate that the alkaline solution or the like comes in contact with only the surface of the transparent support to be saponified. Besides spreading, spraying and contact with a belt or the like impregnated with an alkaline solution are included. Since the use of these methods requires the provision of separate facilities and steps for spreading the alkaline solution, the dipping method (1) is preferred from the standpoint of cost. However, since the coating method involves the contact with only the surface of the transparent support to be saponified, it is advantageous in that the opposite side of the transparent support can be made of a material which is easily affected by alkaline solution. For example, the vacuum deposit or sol-gel layer is subject to various effects such as corrosion, dissolution and exfoliation by alkaline solution and is preferably not formed by the dipping method but may be formed by the coating method without any problems because it requires no contact with the alkaline solution.

Both the aforementioned saponification methods (1) and (2) can be conducted after the formation of the various layers on the support unwound from the roll. Therefore, these saponification methods can be each conducted as a continuous step following the aforementioned step of producing the anti-reflection film. Further, by subsequently conducting the step of sticking the film to a polarizing film of continuous length unwound, the polarizing plate can be prepared more efficiently than the similar process conducted in the form of sheet.

(3) Method which Comprises Saponifying Anti-Reflection Film Protected by Laminate Film

In the case where the hard coat layer or low refractive index layer has an insufficient resistance to alkaline solution as in the aforementioned method (2), a method may be effected which comprises laminating the hard coat layer having a low refractive index layer formed thereon with a laminate film on the low refractive index layer side thereof, dipping the laminate in an alkaline solution to hydrophilicize only the triacetyl cellulose side, which is opposite the low refractive index layer side, and then peeling the laminate film off the low refractive index layer. In accordance with this method, too, hydrophilicization required only for protective film for polarizing plate can be made on only the side of the triacetyl cellulose film opposite the anti-reflection layer without any damage on the hard coat layer and low refractive index layer. As compared with the aforementioned method (2), the method (3) involves the disposal of the laminate film but is advantageous in that it requires no special apparatus for spreading an alkaline solution.

(4) Method which Comprises Dipping the Laminate in an Alkaline Solution after the Formation of Hard Coat Layer

In the case where the laminate is resistant to an alkaline solution up to the hard coat layer but the low refractive index layer is insufficiently resistant to an alkaline solution, the laminate may be dipped in an alkaline solution after the formation of the hard coat layer so that the both sides thereof are hydrophilicized, followed by the formation of the low refractive index layer on the hard coat layer. This method requires complicated productions steps but is advantageous in that the adhesion between the hard coat layer and the low refractive index layer can be enhanced if the low refractive index layer is a layer having a hydrophilic group such as fluorine-containing sol-gel layer.

(5) Method which Comprises Forming an Anti-Reflection Film on a Saponified Triacetyl Cellulose Film

A hard coat layer and a low refractive index layer may be formed on any one side of a triacetyl cellulose film which has been previously saponified by dipping in an alkaline solution directly or with other layers interposed therebetween. When the triacetyl cellulose film is dipped in an alkaline solution to undergo saponification, the adhesion between the hard coat layer or other layers and the triacetyl cellulose film which has been hydrophilicized by saponification can be deteriorated. In this case, the triacetyl cellulose film which has been saponified may be subjected to treatment such as corona discharge and glow discharge only on the side thereof where the hard coat layer or other layers are formed so that the hydrophilicized surface can be removed before the formation of the hard coat layer or other layers. Further, in the case where the hard coat layer or other layers have a hydrophilic group, the interlayer adhesion may be good.

A polarizing plate comprising the anti-reflection film of the invention and a liquid crystal display comprising the polarizing plate will be described hereinafter.

(Polarizing Plate)

A preferred polarizing plate of the invention has an anti-reflection film of the invention as at least one of the protective films for polarizing film (polarizing plate protective film). The polarizing plate protective film preferably has a contact angle of from 10° to 50° with respect to water on the surface of the transparent support opposite the anti-reflection structure side, i.e., on the side thereof where it is stuck to the polarizing film as previously mentioned.

The use of the anti-reflection film of the invention as a protective film for polarizing plate makes it possible to prepare a polarizing plate having an anti-reflection capacity excellent in physical strength and light-resistance and drastically reduce the cost and thickness of display.

Further, the constitution of a polarizing plate comprising an anti-reflection film of the invention as one protective film for polarizing plate and an optical compensation film having an optical anisotropy described later as the other protective film for polarizing film makes it possible to prepare a polarizing plate that provides a liquid crystal display with an improved contrast in the daylight and a drastically raised horizontal and vertical viewing angle.

(Optical Compensation Layer)

The polarizing plate may comprise an optical compensation layer (retarder layer) incorporated therein to improve the viewing angle properties of a liquid crystal display screen.

As the optical compensation layer there may be used any material known as such. In respect to the rise of viewing angle, there is preferably used an optical compensation layer having an optically anisotropic layer made of a compound having a discotic structural unit wherein the angle of the discotic compound with respect to the transparent support changes with the distance from the transparent support as disclosed in JP-A-2001-100042.

This angle preferably changes with the rise of the distance from the transparent support side of the optically anisotropic layer.

In the case where the optical compensation layer is used as a protective film for polarizing film, the optical compensation layer is preferably saponified on the side thereof on which it is stuck to the polarizing film. The saponification of the optical compensation layer is preferably conducted in the same manner as mentioned above.

Other preferred embodiments include a configuration wherein the optically anisotropic layer further comprises a cellulose ester, a configuration wherein an alignment layer is formed interposed between the optically anisotropic layer and the transparent support, and a configuration wherein the transparent support of the optical compensation film having an optically anisotropic layer has an optically negative monoaxiality and an optical axis along the line normal to the surface thereof and satisfies the following requirements:
20<{(nx+ny)/2−nz}×d<400
wherein nx represents the in-plane refractive index in the direction along the slow axis (direction in which the refractive index is maximum); ny represents the in-plane refractive index in the direction along the fast axis (direction in which the refractive index is minimum); nz is the refractive index in the thickness direction; and d represents the thickness of the optical compensation layer.
(Polarizing Film)

As the polarizing film there may be used a known polarizing film or a polarizing film cut out of a polarizing film of continuous length having an absorption axis which is neither parallel to nor perpendicular to the longitudinal direction. The polarizing film of continuous length having an absorption axis which is neither parallel to nor perpendicular to the longitudinal direction is prepared by the following method.

This is a polarizing film stretched by tensing a continuously supplied polymer while being retained at the both ends thereof by a retainer. In some detail, the polarizing film can be produced by a stretching method which comprises stretching the film by a factor of from 1.1 to 20.0 at least in the crosswise direction in such a manner that the difference in longitudinal progress speed of retainer between at both ends is 3% or less and the direction of progress of film is deflexed with the film retained at the both ends thereof such that the angle of the direction of progress of film at the outlet of the step of retaining both ends of the film with respect to the substantial direction of film stretching is from 20° to 70°. In particular, those obtained under the aforementioned conditions wherein the inclination angle is 45° are preferably used from the standpoint of productivity.

For the details of the method of stretching polymer film, reference can be made to JP-A-2002-86554, paragraphs (0020) to (0030).

(Image Display)

The image display of the invention comprises at least one sheet of the aforementioned polarizing plate of the invention (polarizing plate with anti-reflection properties) disposed on the image display surface thereof. The anti-reflection layer, the anti-reflection film and the polarizing plate of the invention can be applied to an image display such as liquid crystal display (LCD) and organic EL display. The image display of the invention is preferably applied to transmission type, reflection type or semi-transmission type liquid crystal display of any of TN mode, IPS mode, VA mode and OCB mode. This will be further described hereinafter.

As the liquid crystal display there may be used any of known liquid crystal displays. Examples of these liquid crystal displays include those disclosed in Tatsuo Uchida, “Hanshagata Kara LCD Sogo Gijutsu (General Technology of Reflective Color LCD)”, CMC, 1999, “Furatto Paneru Disuprei no Shintenkai (New Development of Flat Panel Display)”, Research Department of Toray Research Center Co., Ltd., 1996, “Ekisho Kanren Shijo no Genjo to Shorai Tenbo (jokan), (gekan) (Present Situation and Future Scope of Liquid Crystal-related Market (Vol. I), (Vol. II))”, Fuji Chimera Research Institute, Inc., 2003, etc.

In some detail, the anti-reflection film of the invention is preferably used in transmission type, reflection type or semi-transmission type liquid crystal displays of mode such as twisted nematic (TN), supertwisted nematic (STN), vertical alignment (VA), in-plane switching (IPS) and optically compensated bend cell (OCB).

The polarizing plate of the invention exhibits a good contrast, a wide viewing angle and a good durability and can prevent the change of hue and the reflection of external light to advantage even if the size of the screen of the liquid crystal display on which it is mounted is 17 inches or more.

(TN Mode Liquid Crystal Display)

A TN mode liquid crystal cell is most widely used as a color TFT liquid crystal display. For details, reference can be made to numeral literatures. Referring to the alignment in the liquid crystal cell during the black display of TN mode, rod-shaped liquid crystal molecules are oriented vertically at the central part of the cell but horizontally in the vicinity of the substrate of the cell.

(OCB Mode Liquid Crystal Display)

An OCB mode liquid crystal cell is a liquid crystal cell of bend alignment mode wherein rod-shaped liquid crystal molecules are oriented in substantially opposing directions (symmetrically) from the upper part to the lower part of the liquid crystal cell. A liquid crystal display comprising a bend alignment mode liquid crystal cell comprises devices disclosed in U.S. Pat. Nos. 4,583,825 and 5,410,422 oriented symmetrically with each other from the upper part to the lower part of the liquid crystal cell. Therefore, the bend alignment mode liquid crystal cell has a self optical compensation capacity. Accordingly, this liquid crystal mode is also called OCB (optically compensated bend) liquid crystal mode.

In OCB mode liquid crystal cell, too, rod-shaped liquid crystal molecules are oriented vertically at the central part of the liquid crystal cell but are oriented horizontally in the vicinity of the substrate of the cell during black display as in TN mode.

(VA Mode Liquid Crystal Display)

In a VA mode liquid crystal cell, rod-shaped liquid crystal molecules are oriented vertically oriented when no voltage is applied.

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell (1), there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode) (as disclosed in Preprints of Symposium on Japanese Liquid Crystal Society Nos. 58 to 59, 1998 and (4) liquid crystal cell of SURVALVAL mode (as reported in LCD International 98).

(Ips Mode Liquid Crystal Display)

An IPS mode liquid crystal cell is arranged such that liquid crystal molecules are always rotated in a horizontal plane with respect to the substrate and, when no voltage is applied, are oriented at some angle with respect to the longitudinal direction of the electrode. When an electric field is applied, the liquid crystal molecules are oriented in the direction of electric field. The disposition of polarizing plates having a liquid crystal cell interposed therebetween at a predetermined angle makes it possible to change the light transmission. As the liquid crystal molecule there is used a nematic liquid crystal having a positive dielectric anisotropy Δε. The thickness (gap) of the liquid crystal layer is from more than 2.8 μm to less than 4.5 μm. This is because when the retardation Δn·d ranges from more than 0.25 μm to less than 0.32 μm, there can be provided transmission properties showing little or no wavelength dependence in the visible light range. By properly combining polarizing plates, a maximum transmission can be obtained when the liquid crystal molecules are rotated at an angle of 45° from the rubbing direction to the direction of electric field. The thickness (gap) of the liquid crystal layer is controlled by polymer beads. It goes without saying that the same gap can be obtained also by the use of glass beads, glass beads or columnar space made of resin. The liquid crystal molecule is not specifically limited so far as it is a nematic liquid crystal. The greater the dielectric anisotropy Δε is, the more can be reduced the driving voltage. The smaller the refractive anisotropy Δn is, the greater can be the thickness (gap) of the liquid crystal layer, the shorter can be the time required to enclose liquid crystal and the less can be the gap dispersion.

(Other Liquid Crystal Modes)

For ECB mode and STN mode liquid crystal displays, the polarizing plate of the invention can be provided with the same conception as described above.

(Display)

The formation of the liquid crystal display can be conducted according to any related art method. In some detail, a liquid crystal display is normally formed by properly combining a liquid crystal cell, an optical film and optionally constituent parts such as illumination system, and then incorporating a driving circuit thereinto. In the invention, the method of forming a liquid crystal display is not specifically limited except the use of the liquid crystal display element of the invention but may be according to the related art.

In order to form the liquid crystal display, proper parts such as prism array, lens array sheet, light-scattering plate, light guide plate and backlight may be disposed at a proper position in one or more layers. Further, when combined with a λ/4 plate, the polarizing plate of the invention can be used as a polarizing plate for reflective liquid crystal or surface protective plate for organic EL display to reduce the amount of light rays reflected by the surface and interior of the display.

### EXAMPLE

The invention will be further described in the following examples, but the scope of the invention should not be construed as being limited thereto. The terms “parts” and “%” as used hereinafter are by weight unless otherwise specified.
(Synthesis of Perfluoroolefin Copolymer (1))

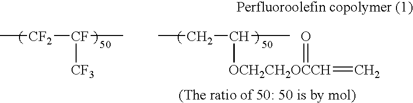

In a 100 ml stainless steel autoclave with agitator were charged 40 ml of ethyl acetate, 14.7 g of hydroxyethyl vinyl ether and 0.55 g of dilauroyl peroxide. The air in the system was then evacuated and purged with nitrogen gas. Into the autoclave was then introduced 25 g of hexafluoropropylene (HFP). The autoclave was then heated to 65° C. The pressure in the autoclave developed when the internal temperature of the autoclave reached 65° C. was 0.53 MPa. The reaction then lasted for 8 hours at a temperature kept at 65° C. When the pressure in the autoclave reached 0.31 MPa, heating was then suspended to let the autoclave to cool. When the internal temperature of the autoclave reached room temperature, the unreacted monomers were then driven out of the autoclave. The autoclave was then opened to withdraw the reaction solution. The reaction solution thus obtained was then poured into a large excess of hexane. The solvent was then removed from the reaction solution by decantation to withdraw a precipitated polymer. The polymer thus obtained was dissolved in a small amount of ethyl acetate, and then reprecipitated twice from hexane to remove the residual monomers completely. The residue was then dried to obtain 28 g of a polymer. Subsequently, 20 g of the polymer was dissolved in 100 ml of N,N-dimethylacetamide. To the solution was added dropwise 11.4 g of chloride of acrylic acid under ice cooling. Thereafter, the mixture was stirred at room temperature for 10 hours. To the reaction solution was then added ethyl acetate. The reaction solution was washed with water. The organic phase was extracted, and then concentrated. The polymer thus obtained was then reprecipitated from hexane to obtain 19 g of a perfluoroolefin copolymer (1). The refractive index of the polymer thus obtained was 1.421.

(Preparation of Organosilane Solution A)

In a reactor equipped with agitator and reflux condenser were charged 120 parts of methyl ethyl ketone, 100 parts of acryloyloxy propyl trimethoxysilane (KBM-5103, produced by Shin-Etsu Chemical Co., Ltd.) and 3 parts of diisopropoxy aluminum ethyl acetoacetate (Kelope EP-12, produced by Hope Chemical Co., Ltd.). The mixture was then stirred. To the mixture were then added 30 parts of deionized water. The reaction mixture was then reacted at 60° C. for 4 hours. The reaction mixture was then allowed to cool to room temperature to obtain an organosilane solution. The weight-average molecular weight of the organosilane solution thus obtained was 1,600. The proportion of the components having a weight-average molecular weight of from 1,000 to 20,000 in the oligomer components and higher components was 100%. The gas chromatography of the reaction product showed that none of the acryloyloxy propyl trimethoxysilane as raw material remained.

(Preparation of Organosilane Sol B)

An organosilane sol B was prepared in the same manner as in the preparation of the aforementioned organosilane sol A except that 25 parts by weight of acryloyloxy propyltrimethoxysilane and 75 parts by weight of tridecafluorooctyl trimethoxysilane were used instead of 100 parts by weight of acryloyloxy propyltrimethoxysilane.

(Preparation of coating solution for hard coat layer)

| | |
|---|---|
| KAYARAD DPCA-20, produced by | 100 parts by weight |
| NIHON KAYAKU CO., LTD. (mixture of partly | |
| caprolactone- modified dipentaerythritol | |
| hexaacrylates; 2 mols added on the | |
| average (unit/mol)) | |
| Methyl ethyl ketone | 90 parts by weight |
| Cyclohexanone | 10 parts by weight |
| Irgacure 907 (produced by | 3 parts by weight |
| Ciba Speciality Chemicals Co., Ltd.) | |

These components were mixed, stirred, and then filtered through a polypropylene filter having a pore diameter of 0.4 μm.

(Preparation of dispersion of particulate titanium dioxide)

| | |
|---|---|
| MPT-129C (produced by ISHIHARA SANGYO | 257.1 parts by weight |
| KAISHA, LTD.; | |
| TiO₂:Co₃O₄:Al₂O₃:ZrO₂ = 90.5:3.0:4.0:0.5 | |
| by weight) | |
| Dispersant described below | 38.6 parts by weight |
| Cyclohexanone | 704.3 parts by weight |

These components were mixed, and then dispersed by a dinomill until a weight-average particle diameter of 70 nm was reached.

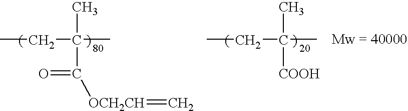

(Preparation of middle refractive index layer coating solution A)

| | | |
|---|---|---|
| Titanium dioxide dispersion described above | 88.9 | parts by weight |
| KAYARAD DPHA (produced by | 58.4 | parts by weight |
| NIHON KAYAKU CO., LTD.) | | |
| Irgacure 907 (produced by Ciba | 3.1 | parts by weight |
| Specialty Chemicals Co., Ltd.) | | |
| Kayacure DETX (produced by | 1.1 | parts by weight |
| NIHON KAYAKU CO., LTD.) | | |
| Methyl ethyl ketone | 482.4 | parts by weight |
| Cyclohexanone | 1,869.8 | parts by weight |

These components were mixed, stirred, and then filtered through a polypropylene filter having a pore diameter of 0.4 μm.

(Preparation of high refractive index layer coating solution A)

| | | |
|---|---|---|
| Titanium dioxide dispersion described above | 586.8 | parts by weight |
| KAYARAD DPHA (produced by | 47.9 | parts by weight |
| NIHON KAYAKU CO., LTD.) | | |
| Irgacure 907 (produced by Ciba | 4.0 | parts by weight |
| Specialty Chemicals Co., Ltd.) | | |
| Kayacure DETX (produced by | 1.3 | parts by weight |
| NIHON KAYAKU CO., LTD.) | | |
| Methyl ethyl ketone | 455.8 | parts by weight |
| Cyclohexanone | 1,427.8 | parts by weight |

These components were mixed, stirred, and then filtered through a polypropylene filter having a pore diameter of 0.4 μm.

(Preparation of Hollow Silica Dispersion)

To 500 parts by weight of a hollow particulate silica sol (particle size: approx. 40 to 50 nm; shell thickness: 6 to 8 nm; refractive index: 1.31; solid content concentration: 20%; main solvent: isopropyl alcohol; prepared with particle size being varied according to Preparation Example 4 in JP-A-2002-79616) were added 30 parts by weight of acryloyloxy propyl trimethoxysilane (KBM-5103, produced by Shin-Etsu Chemical Co., Ltd.) and 1.5 parts by weight of diisopropoxy aluminum ethyl acetoacetate (trade name: Kelope EP-12, produced by Hope Chemical Co., Ltd.). The mixture was then stirred. To the mixture were then added 9 parts by weight of deionized water. The reaction mixture was allowed to undergo reaction at 60° C. for 8 hours, and then allowed to cool to room temperature. To the mixture were then added 1.8 parts by weight of acetyl acetone to obtain a hollow silica dispersion. The hollow silica dispersion thus obtained had a solid content concentration of 18% by weight and showed a refractive index of 1.31 after dried.

(Preparation of low refractive index layer coating solution A)

| | | |
|---|---|---|
| KAYARAD DPHA (produced by | 1.4 | parts by weight |
| NIHON KAYAKU CO., LTD.) | | |
| Perfluoroolefin copolymer(1) | 5.6 | parts by weight |
| Hollow silica dispersion | 20.0 | parts by weight |
| RMS-033 (produced by GEKEST) | 0.7 | parts by weight |
| Irgacure 907 (produced by Ciba | 0.2 | parts by weight |
| Specialty Chemicals Co., Ltd.) | | |
| Organosilane sol A | 6.2 | parts by weight |
| MEK | 305.9 | parts by weight |
| Cyclohexanone | 10.0 | parts by weight |

(Preparation of low refractive index layer coating solution B)

| | | |
|---|---|---|
| Organosilane sol B | 10.0 | parts by weight |
| X-22-164C, produced by Shin | 0.04 | parts by weight |
| Etsu Chemical Co., Ltd. | | |
| Dimethylamino benzene | 0.04 | parts by weight |
| Irgacure 907, produced by Ciba | 0.1 | parts by weight |
| Specialty Chemicals, Inc. | | |
| MEK | 87.0 | parts by weight |
| Cyclohexanone | 2.8 | parts by weight |

### Example 1

### (1) Coating of Hard Coat Layer Coating Solution

Using a microgravure roll having a gravure pattern of 80 lines per inch and a depth of 40 μm and a diameter of 50 mm and a doctor blade, the hard coat layer coating solution was coated over a triacetyl cellulose film having a width of 1,340 mm and a thickness of 80 μm (TDY80UL, produced by Fuji Optomaterials Co., Ltd.; refractive index nb: 1.486) which was being unwound from roll at a gravure roll rotary speed of 65 rpm and a conveying speed of 20 m/min. 60° C. drying air was blown onto the coat layer at a flow rate of from 0.1 m/sec to 2 m/sec wherein the flow rate increases from the former half of the drying zone to the latter half of the drying zone for a total of 150 seconds. Using a 160 W/cm air-cooled metal halide lamp (produced by EYE GRAPHICS CO., LTD.) while the air in the system was being purged with nitrogen, the coat layer was cured by irradiating with ultraviolet rays at an illuminance of 200 mW and a dose of 120 mJ/cm² to form a hard coat layer having a refractive index nh of 1.505 (nh/nb=1.01) to a thickness of 6.3 μm as calculated by fitting from 5 degree specular reflectance using a method as described later (plus 0.1 μm, which is the thickness at which ΔEab* is minimum). The film was then wound.

### (2) Coating of Low Refractive Index Layer Coating Solution

Using a microgravure roll having a gravure pattern of 180 lines per inch and a depth of 40 μm and a diameter of 50 mm and a doctor blade, the aforementioned low refractive index layer coating solution was coated over the triacetyl cellulose film having a hard coat layer provided thereon which was being unwound from roll at a gravure roll rotary speed of 30 rpm and a conveying speed of 15 m/min. The coat layer was dried at 90° C. for 150 seconds. Using a 240 W/cm air-cooled metal halide lamp (produced by EYE GRAPHICS CO., LTD.), the coat layer was cured by irradiating with ultraviolet rays at an illuminance of 400 mW and a dose of 900 mJ/cm² in an oxygen concentration of 0.1% by volume while the air in the system was being purged with nitrogen to form a low refractive index layer having a refractive index of 1.43 to a thickness of 90 nm. The film was then wound.

### (3) Saponification of anti-reflection film

The film thus prepared was then subjected to the following treatment.

A 1.5 mol/l aqueous solution of sodium hydroxide was prepared. The aqueous solution thus prepared was then kept at 55° C. A 0.01 mol/l diluted aqueous solution of sulfuric acid was prepared. The aqueous solution thus prepared was then kept at 35° C. The anti-reflection film prepared was dipped in the aforementioned aqueous solution of sodium hydroxide for 2 minutes, and then dipped in water so that the aqueous solution of sodium hydroxide was thoroughly washed away. Subsequently, the anti-reflection film was dipped in the aforementioned diluted aqueous solution of sulfuric acid for 1 minute, and then dipped in water so that the diluted aqueous solution of sulfuric acid was thoroughly washed away. Finally, the sample was thoroughly dried at 120° C.

In this manner, a saponified anti-reflection film was prepared. Thus, a sample of Example 1 was obtained.

(Evaluation of Anti-Reflection Film)

The film thus obtained was then evaluated for the following properties. The results are set forth in Table 1.

(1) Average Reflectance

The sample having a hard coat layer provided thereon and the sample having a low refractive index layer provided thereon were each roughened by rubbing the back surface thereof with a #400 sandpaper 30 times, coated with a black ink on the back surface thereof to cut reflection on the back surface, and then measured for spectral reflectance at an incidence angle of 5° at a wavelength of from 380 to 780 nm using a spectrophotometer (produced by JASCO). For the determination of average reflectance, measurements of reflectance were arithmetically averaged over the wavelength range of from 450 to 650 nm. For the sample having a hard coat layer provided thereon, refractive index (approximated by Cauchy parameter) and thickness were calculated by fitting.

(2) Unevenness in Color of Hard Coat Layer

The sample having a hard coat layer provided thereon which had not yet comprised a low refractive index layer provided thereon was measured for reflection spectrum at an arbitrary one point by the aforementioned method (1), and then measured for reflection spectrum at arbitrary three points 5 mm, 10 mm and 30 mm apart from the former arbitrary point, respectively, in the longitudinal or crosswise direction. Subsequently, the color (L*, a*, b*) of reflected light on the various points with respect to CIE F12 light source (three wavelength type fluorescent lamp) was calculated to determine the color unevenness ΔEab* relative to the first arbitrary point.

(2) Pencil Scratch Test

The samples were evaluated for pencil hardness according to JIS K-5600-5-4 except that the load was 500 g.

(3) Unevenness in Interference of Anti-Reflection Film

The anti-reflection film was evaluated for flatness according to the following criterion in the following manner. In some detail, an anti-reflection film sample having an area of (1,340 mm width×1 m length) was laminated with a black film on the side thereof opposite the anti-reflection layer so that it causes no reflection on the back side thereof. Under a scattering light source comprising a three-wavelength type white fluorescent lamp (National FPL27EX-N) covered with a scattering cover turned on in a dark room, the anti-reflection film sample was visually observed. The results were then evaluated according to the following criterion.

| | |
|---|---|
| Strong unevenness in interference observed | P |
| Slightly strong unevenness in interference observed | FP |
| Slight but inoffensive unevenness observed | F |
| Little or no unevenness in interference observed | G |
| No unevenness in interference observed | E |

(4) Curling

A specimen having a size of 500 mm (longitudinal direction)×1,340 mm (same as the width of the raw sheet) was sampled from the anti-reflection film. The specimen was then placed on a flat table with the anti-reflection layer upside. Under these conditions, the specimen was visually observed for curling. The results were then evaluated according to the following criterion.

| | |
|---|---|
| Much curled, uncertain handling | P |
| Much curled, but no problems with handling | F |
| Little curled, no problems with handling | G |

(5) Brittleness

The sample was subjected to mandrel test according to JIS K-5600-5-1. The test results were evaluated according to the following criterion.

| | |
|---|---|
| No cracking at 5 mm | E |
| No cracking up to 8 mm | G |
| No cracking up to 20 mm | F |
| Cracking at 25 mm to 32 mm | P |

(6) Point Defect

100 sheets of a hard coat layer-coated film having a length of 1 m were sampled. These samples were each laminated with a black film on the side thereof opposite the hard coat layer so that they cause no reflection on the back side thereof. Under a point light source, these samples were each visually observed on the hard coat layer side thereof to count the number of point defects. The results were then averaged to determine the number of point defects per m². The point defects thus visually detected were then observed under optical microscope. As a result, it was found that all the point defects had a size of 50 μm or more.

(Samples 2, 3, 6 to 11 (Inventive), 4, 5 (Comparative of Example 1)

Samples were prepared in the same manner as in Sample 1 of Example 1 by forming up to the anti-reflection layer in the same manner as in Sample 1 of Example 1 except that either or both the thickness of the hard coat layer and the coating solution for low refractive index layer were changed for all the samples and heat curing was conducted at 120° C. for 10 minutes and saponification was conducted with the coat layer protected by a laminate film only for Samples 7 and 8 of Example 1 as set forth in Table 1. The results are set forth in Table 1. All the samples showed a color change by a factor of 1.2 after having a low refractive index layer formed therein as an anti-reflection layer. However, the inventive samples showed ΔEab* of 1.0 or less in all the arbitrary points 5 mm, 10 mm and 30 mm, respectively, apart from the first arbitrary point.

TABLE 1

| | Hard coat layer | | | | | | | Other properties | | | |
|---|---|---|---|---|---|---|---|---|---|---|---|
| | | ΔEab* | | | Low refractive | | | | | | Point |
| | Thickness | 5 | 10 | 30 | index layer | Reflectance | Pencil | Unevenness in | | Brittle- | defect |
| | (μm) | mm | mm | mm | Coating solution | % | hardness | interference | Curling | ness | (/m²) |
| Sample 1 (inventive) | 6.3 | 0.3 | 0.5 | 0.5 | A | 1.9 | 3H | E | G | G | 0.30 |
| Sample 2 (inventive) | 6.8 | 0.3 | 0.5 | 0.5 | A | 1.9 | 3H | E | G | G | 0.10 |
| Sample 3 (inventive) | 7.7 | 0.2 | 0.3 | 0.3 | A | 1.9 | 3H | E | G | G | 0.05 |
| Sample 4 (inventive) | 8.2 | 0.1 | 0.2 | 0.2 | A | 1.9 | 3H | E | G | G | 0.02 |
| Sample 5 (comparative) | 4.0 | 2.3 | 3.0 | 3.0 | A | 1.9 | H | P | G | G | 5.00 |
| Sample 6 (comparative) | 17.0 | 0.1 | 0.1 | 0.1 | A | 1.9 | 3H | E | P | P | 0.01 |
| Sample 7 (inventive) | 6.8 | 0.3 | 0.5 | 0.5 | B | 1.5 | 3H | E | G | G | 0.30 |
| Sample 8 (inventive) | 8.2 | 0.1 | 0.2 | 0.2 | B | 1.5 | 3H | E | G | G | 0.02 |

The results set forth in Table 1 show the following facts.

The samples having the hard coat layer of the invention provided thereon show improvements such that little or no unevenness in interference can be seen. These inventive samples are excellent also in curling resistance, brittleness and point defect. On the other hand, the comparative samples are disadvantageous in curling resistance and brittleness when they have a thickness as great as described above. When they have a smaller thickness, they undergo increased unevenness in interference and point defects to disadvantage.

As mentioned above, the invention provides an anti-reflection layer which exhibits little unevenness in coating particularly when observed under an artificial light source.

### Example 2

### (1) Spreading and Saponification of Hard Coat Layer/Three-Layer Anti-Reflection Layer

The same hard coat layers (HC layer) as in Samples 1 to 8 of Example 1 were each formed on a triacetyl cellulose film having a thickness of 80 μm (TDY80UL, produced by Fuji Optomaterials Co., Ltd.). Subsequently, the aforementioned middle refractive index layer coating solution, high refractive index layer coating solution and low refractive index layer coating solution A were coated over each of the hard coat layers under the same coating conditions as in the low refractive index layer of Example 1, and then subjected to drying of solvent and irradiation with ultraviolet rays under the same conditions as set forth in Table 2 to form a middle refractive index layer (Mn layer), a high refractive index layer (Hn layer) and a low refractive index layer (Ln layer) in this order. Thus, films having a hard coat layer and a three-layer anti-reflection layer formed thereon were obtained. These films were each then saponified in the same manner as in Example 1 to prepare Samples 1 to 8 of Example 2 which were then evaluated. The results of evaluation are set forth in Table 3.

TABLE 2

| | Temperature | Dose of | | | |
|---|---|---|---|---|---|
| | of | ultraviolet | Oxygen | Dry | |
| | drying air | rays | concentration | thickness | Refractive |
| Layer | (° C.) | (mJ/cm²) | (vol-%) | (nm) | index |
| HC | 60 | 120 | 0.1 | 8,500 | 1.51 |
| Mn | 110 | 300 | 0.1 | 65 | 1.63 |
| Hn | 110 | 500 | 0.1 | 105 | 1.90 |
| Ln | 90 | 900 | 0.05 | 84 | 1.43 |

All the samples showed a color change by a factor of 1.8 after having a low refractive index layer formed therein as an anti-reflection layer. However, the inventive samples showed Δab* of 1.2 or less in all the arbitrary points 5 mm, 10 mm and 30 mm, respectively, apart from the first arbitrary point.

TABLE 3

| | Hard coat layer | | | | | | | Other properties | | | |
|---|---|---|---|---|---|---|---|---|---|---|---|
| | | ΔEab* | | | Low refractive | | | | | | Point |
| | Thickness | 5 | 10 | 30 | index layer | Reflectance | Pencil | Unevenness in | | Brittle- | defect |
| | (μm) | mm | mm | mm | Coating solution | % | hardness | interference | Curling | ness | (/m²) |
| Sample 1 (inventive) | 6.3 | 0.3 | 0.5 | 0.5 | A | 0.32 | 3H | G | G | G | 0.30 |
| Sample 2 (inventive) | 6.8 | 0.3 | 0.5 | 0.5 | A | 0.32 | 3H | G | G | G | 0.10 |
| Sample 3 (inventive) | 7.7 | 0.2 | 0.3 | 0.3 | A | 0.32 | 3H | E | G | G | 0.05 |
| Sample 4 (inventive) | 8.2 | 0.1 | 0.2 | 0.2 | A | 0.32 | 3H | E | G | G | 0.02 |
| Sample 5 (comparative) | 4.0 | 2.3 | 3.0 | 3.0 | A | 0.32 | H | P | G | G | 5.00 |
| Sample 6 (comparative) | 17.0 | 0.1 | 0.1 | 0.1 | A | 0.32 | 3H | E | P | P | 0.01 |
| Sample 7 (inventive) | 6.8 | 0.3 | 0.5 | 0.5 | B | 0.25 | 3H | G | G | G | 0.30 |
| Sample 8 (inventive) | 8.2 | 0.1 | 0.2 | 0.2 | B | 0.25 | 3H | G | G | G | 0.02 |

The results set forth in Table 3 show the following facts.

The samples having the hard coat layer of the invention provided thereon show improvements such that little or no unevenness in interference can be seen. These inventive samples are excellent also in curling resistance, brittleness and point defect. On the other hand, the comparative samples are disadvantageous in curling resistance and brittleness when they have a thickness as great as described above. When they have a smaller thickness, they undergo increased unevenness in interference and point defects to disadvantage.

As mentioned above, the invention provides an anti-reflection layer which exhibits little unevenness in coating particularly when observed under an artificial light source.

### Example 3

A PVA film was dipped in an aqueous solution of 2.0 g/l of iodine and 4.0 g/l of potassium iodide at 25° C. for 240 seconds, dipped in an aqueous solution of 10 g/l of boric acid at 25° C. for 60 seconds, introduced into a tenter stretching machine as shown in FIG. 2 in JP-A-2002-86554 where it was then stretched by a factor of 5.3, and then kept constant in width by the tenter which had been bent with respect to the stretching direction as shown in FIG. 2. The film was dried in a 80° C. atmosphere, and then released from the tenter. The difference in conveying speed between the right and left tenter clips was less than 0.05%. The angle between the central line of the film thus introduced and the central line of the film fed to the subsequent step was 46°. Herein, |L1−L2| was 0.7 m, W was 0.7 m, and there can be established the relationship |L1−L2|=W. The substantial stretching direction Ax-Cx at the outlet of the tenter was oblique to the central line 22 of the film fed to the subsequent step at an angle of 45°. No wrinkling and deformation were observed on the film at the outlet of the tenter.

Further, the film thus obtained was stuck to a saponified Fujitac (TD80UL) (produced by Fuji Photo Film Co., Ltd.) with a 3% aqueous solution of PVA (PVA-117H, produced by Kuraray Co., Ltd.) as an adhesive, and then dried at 80° C. to obtain a polarizing plate having an effective width of 650 mm. The absorption axis direction of the polarizing plate thus obtained was oblique to the longitudinal direction at an angle of 45°. The transmission and polarization degree of the polarizing plate at 550 nm were 43.7% and 99.97%, respectively. The polarizing plate was then cut into a size of 310 mm×233 mweighthown in FIG. 2 in the above cited patent. As a result, a polarizing plate having an area efficiency of 91.5% the absorption axis of which is oblique to the side thereof at an angle of 45° was obtained.

Subsequently, Sample 1 of Example 1 and Sample 1 of Example 2 (both saponified) were each stuck to the aforementioned polarizing plate to prepare polarizing plates with anti-reflection properties. Liquid crystal displays were then prepared from these polarizing plates with their anti-reflection layer disposed as an outermost layer. These liquid crystal displays didn't cause reflection of external light and thus provided an excellent contrast and hence an excellent viewability. In particular, the liquid crystal display comprising the film of Sample 1 of Example 2 exhibited a low reflectance and hence an excellent contrast.

### Example 4

A triacetyl cellulose film having a thickness of 80 μm (TAC-TD80U, produced by Fuji Photo Film Co., Ltd.) which had been dipped in a 1.5 mol/l aqueous solution of NaOH at 55° C. for 2 minutes, neutralized and then rinsed and the saponified triacetyl cellulose film of the anti-reflection films of Sample 1 of Example 1 and Sample 1 of Example 2 were bonded to the respective side of a known polarizer prepared by allowing a polyvinyl alcohol film to adsorb iodine and then stretching the film to protect the polarizer. Thus, a polarizing plate was prepared. The polarizing plate thus prepared was then bonded to the liquid crystal display of a note personal computer having a transmission type TN liquid crystal display incorporated therein (comprising D-BEF, which is a polarization separating film having a polarization selective layer produced by Sumitomo 3M Co., Ltd., provided interposed between a backlight and a liquid crystal cell) with the anti-reflection layer disposed at outermost surface to replace the polarizing plate on the viewing side thereof. As a result, a display which causes extremely little reflection of background and exhibits a very high display quality was obtained.

### Example 5

As each of the protective film on the liquid crystal side of the polarizing plate on the viewing side and the protective film on the liquid crystal cell side of the polarizing plate on the backlight side of the transmission type TN liquid crystal cell comprising the anti-reflection film of Sample 1 of Example 1 and Sample 1 of Example 2 bonded thereto there was used a wide view film (Wide View Film SA 12B, produced by Fuji Photo Film Co., Ltd.). As a result, a liquid crystal display having an excellent contrast in the daylight, very wide vertical and horizontal viewing angles, an extremely excellent viewability and a high display quality was obtained. In particular, the liquid crystal display comprising the film of Sample 1 of Example 2 exhibited a low reflectance and hence an excellent contrast.

### Example 6

Sample 1 of Example 2 was used to prepare a polarizing plate having an anti-reflection film provided on one side thereof. A λ/4 plate was stuck to the polarizing plate on the side thereof opposite the anti-reflection layer. The laminate was then stuck to an organic EL display on the outermost surface on the display surface thereof. As a result, a display which exhibits inhibited surface reflection and reflection from the interior of the surface glass and an extremely high viewability was obtained.

### Example 7

Anti-reflection film samples 1 to 7 of Example 7 were prepared in the same manner as in Example 1 except that the solvent formulation of the hard coat layer coating solution, the thickness of the hard coat layer and the conditions of air for drying the hard coat layer were changed. These anti-reflection film samples were each then evaluated in the same manner as in Example 1. The results are set forth in Tables 4 and 5.

As can be seen in the results of Tables 4 and 5, the anti-reflection films comprising a hard coat layer of the invention having a dry thickness of from 6 μm to 15 μm and showing a tint difference of 2.0 or less with respect to light reflected by the hard coat layer as calculated in terms of ΔEab* of CIE exhibited good results in interference unevenness, curling, brittleness and point defect.

Further, when as the solvent for the hard coat layer coating composition there was used a solvent having a boiling point of 100° C. or less or the hard coat layer coating composition was dried with drying air at a wind velocity of 1 m/sec or more, interference unevenness can be eliminated to a high extent.

TABLE 4

| | Hard coat layer | | | | | |
|---|---|---|---|---|---|---|
| | | | Wind | | | |
| | | Layer | velocity | | | |
| | | thickness | of drying | ΔEab* | | |
| | Solvent formulation | (μm) | air (m/s) | 5 mm | 10 mm | 30 mm |
| Sample 1 (inventive) | MEK/cyclohexanone = 60/40 | 7.0 | 0.5 | 1.0 | 1.2 | 0.9 |
| Sample 2 (inventive) | MEK/cyclohexanone = 60/40 | 7.0 | 1.5 | 0.6 | 0.4 | 0.4 |
| Sample 3 (inventive) | MEK/cyclohexanone = 60/40 | 7.0 | 3.0 | 0.1 | 0.2 | 0.1 |
| Sample 4 (comparative) | MEK/cyclohexanone = 60/40 | 5.0 | 0.5 | 2.5 | 2.9 | 2.8 |
| Sample 5 (inventive) | IPA/MIBK = 40/60 | 7.0 | 1.5 | 1.0 | 1.3 | 1.0 |
| Sample 6 (comparative) | IPA/MIBK = 40/60 | 5.0 | 0.5 | 2.8 | 3.5 | 3.2 |
| Sample 7 (inventive) | MIBK = 100 | 7.0 | 1.5 | 1.8 | 1.6 | 1.6 |

TABLE 5

| | | | | Other properties | | | |
|---|---|---|---|---|---|---|---|
| | Low refractive | Reflectance | Pencil | Unevenness in | | | Point defect |
| | layer | % | hardness | interference | Curling | Brittleness | (/m²) |
| Sample 1 (inventive) | A | 1.9 | 3H | G | G | G | 0.15 |
| Sample 2 (inventive) | A | 1.9 | 3H | E | G | G | 0.14 |
| Sample 3 (inventive) | A | 1.9 | 3H | E | G | G | 0.14 |
| Sample 4 (comparative) | A | 1.9 | 2H | P | G | G | 2.00 |
| Sample 5 (inventive) | A | 1.9 | 3H | G | G | G | 0.18 |
| Sample 6 (comparative) | A | 1.9 | 2H | P | G | G | 2.30 |
| Sample 7 (inventive) | A | 1.9 | 3H | F | G | G | 0.12 |

It will be apparent to those skilled in the art that various modifications and variations can be made to the described preferred embodiments of the invention without departing from the spirit or scope of the invention. Thus, it is intended that the present invention cover all modifications and variations of this invention consistent with the scope of the appended claims and their equivalents.

This application is based on Japanese Patent Application No. JP2004-235400 filed on Aug. 12 of 2004, the contents of which is incorporated herein by reference.

### INDUSTRIAL APPLICABILITY

An anti-reflection film according to the invention can be applied to a polarizing plate and an image display such as liquid crystal display (LCD) and organic EL display.

1. An anti-reflection film comprising:
a transparent support;
a hard coat layer comprising a transparent resin; and
a low refractive index layer having a lower refractive index than that of both the transparent support and the hard coat layer, in this order,
wherein the hard coat layer has a thickness of 5 to 15 μm, and
a color difference of reflected light, with respect to incident light from an artificial light source, between at a first point on the hard coat layer and at a second point disposed 5 mm apart from the first point in a longitudinal or crosswise direction of the ant-reflection film is 2.0 or less as calculated in terms of ΔEab* value of CIE.

2. An anti-reflection film comprising:
a transparent support;
a hard coat layer comprising a transparent resin; and
a low refractive index layer having a lower refractive index than that of both the transparent support and the hard coat layer, in this order,
wherein the hard coat layer has a thickness of 5 to 15 μm, and
a color difference of reflected light, with respect to incident light from an artificial light source, between at a first point on the hard coat layer and at a second point disposed 10 mm apart from the first point in a longitudinal or crosswise direction of the ant-reflection film is 2.0 or less as calculated in terms of ΔEab* value of CIE.

3. An anti-reflection film comprising:
a transparent support;
a hard coat layer comprising a transparent resin; and
a low refractive index layer having a lower refractive index than that of both the transparent support and the hard coat layer, in this order,
wherein the hard coat layer has a thickness of 5 to 15 μm, and
a color difference of reflected light, with respect to incident light from an artificial light source, between at a first point on the hard coat layer and at a second point disposed 30 mm apart from the first point in a longitudinal or crosswise direction of the ant-reflection film is 2.0 or less as calculated in terms of ΔEab* value of CIE.

4. The anti-reflection film as defined in claim 3, wherein the thickness of the hard coat layer is from 6 to 15 μm.

5. The anti-reflection film as defined in claim 3, which has a ratio nh/nb of a refractive index nh of the hard coat layer to a refractive index nb of the transparent support is from 0.97 to 1.05.

6. The anti-reflection film as defined in claim 3, wherein the thickness of the hard coat layer falls within a range in which an amplitude of a waveform of a graph obtained by the following steps (a) to (e) is minimum:
(a) Step of measuring a specular reflection spectrum of the hard coat layer at an incidence angle of 5° in a wavelength range of from 380 nm to 780 nm;
(b) Step of calculating a color of reflected light with respect to the specular reflection spectrum measured at the step (a) as an L, a* and b* values of CIE using CIE F-12 light source as emission spectrum of artificial illumination;
(c) Step of repeating the step (b) every 0.02 μm over the thickness range of the hard coat layer of from 5 μm to 10 μm;
(d) Step of calculating, as the average color, an average L, a* and b* values of CIE averaged over the thickness range of the hard coat layer of from 5 μm to 10 μm based on results of the step (C), and determining a color change ΔEab* value from the average color at various thicknesses of from 5 μm to 10 μm; and
(e) Step of graphically illustrating the thickness and the ΔEab* value plotted as abscissa and ordinate, respectively, from the results of the step (d).

7. The anti-reflection film as defined in claim 3, wherein the hard coat layer is a layer formed by coating a coating solution comprising: the transparent resin; and a solvent having a boiling point of 100° C. or less, and drying the coating solution.

8. The anti-reflection film as defined in claim 7, wherein the drying of the coating solution is performed with drying air at a wind velocity of 1 m/sec or more.

9. The anti-reflection film as defined in claim 3, wherein the transparent support is a cellulose acylate film having a thickness of from 40 μm to 120 μm.

10. The anti-reflection film as defined in claim 3, wherein
the low refractive index layer is a cured layer formed by coating and curing a curable composition comprising mainly a fluorine-containing polymer containing: fluorine atoms in an amount of from 35 to 80% by weight; a fluorine-containing vinyl monomer polymerizing unit, and a polymerizing unit having a (meth)acryloyl group in a side chain thereof, the copolymer having a main chain of only carbon atoms, and
the low refractive index layer has a refractive index of from 1.30 to 1.55.

11. The anti-reflection film as defined in claim 10, wherein the low refractive index layer is a cured layer formed by coating and curing a curable composition comprising:
(A) the fluorine-containing polymer,
(B) a particulate inorganic material having an average particle diameter of from 30% to 150% of a thickness of the low refractive index layer and a hollow structure having a refractive index of from 1.17 to 1.40: and
(C) at least one of a hydrolyzate and a partial condensate of an organosilane represented by formula (3), the organosilane being produced in the presence of an acid catalyst:
(R¹)ₘ—Si(X)₄₋ₘ (3)
wherein R¹ represents a substituted or unsubstituted alkyl or aryl group; X represents a hydroxyl group or hydrolyzable group; and m represents an integer of from 1 to 3.

12. The anti-reflection film as defined in claim 3, wherein
the low refractive index layer is a cured layer formed by coating and curing a curable composition comprising at least one of a hydrolyzate of a compound represented by the following formula (2) and a dehydration condensate thereof:
(R²)ₙ—Si(Y)₄₋ₙ (2)
wherein R² represents a substituted or unsubstituted alkyl group, partly or fully fluorine-substituted alkyl group or substituted or unsubstituted aryl group; Y represents a hydroxyl group or hydrolyzable group; and n represents an integer of from 0 to 3, and
the low refractive index layer has a refractive index of from 1.30 to 1.55.

13. The anti-reflection film as defined in claim 3, which further comprises a middle refractive index layer having a higher refractive index than that of the hard coat layer; and a high refractive index layer having a higher refractive index than that of the middle refractive index layer in this order, and the middle and high refractive index layers is between the hard coat layer and the low refractive index layer.

14. The anti-reflection film as defined in claim 3, wherein
the low refractive index layer is an uppermost layer in the anti-reflection film, and
a color difference of reflected light, with respect to incident light from an artificial light source, between at a first point on the low refractive index layer and at a second point disposed 10 mm apart from the first point in a longitudinal or crosswise direction of the anti-reflection film is 2.0 or less as calculated in terms of ΔEab* value of CIE.

15. A polarizing plate comprising: a polarizing film; and at two surface protective films, at least one of the two surface protective films comprising an anti-reflection film defined in claim 3.

16. The polarizing plate as defined in claim 15, wherein
one film of the two surface protective films comprises the anti-reflection film,
the other film of the two surface protective films is an optical compensation film having an optical compensation layer comprising an optically anisotropic layer on an opposite side of the other film from the polarizing film, and
the optically anisotropic layer comprises a compound having a discotic structural unit, wherein a disc surface of the discotic structure unit is disposed obliquely to a surface of the other film, and an angle of the disc surface of the discotic structure unit with respect to the surface of the other film changes in a depth direction of the optically anisotropic layer.

17. A liquid crystal display comprising at least one sheet of polarizing plate defined in claim 15.

18. A method of producing an anti-reflection film of claim 3, which comprises:
reverse-roll coating a coating solution of a hard coat layer of the anti-reflection film using a microgravure coating method;
drying a solvent away with heated drying air; and
heating the coating solution or irradiating the coating solution with ionized radiation to cure the coating solution.

19. The method of producing an anti-reflection film as defined in claim 18, wherein the coating solution comprises: the transparent resin; and a solvent having a boiling point of 100° C. or less.

20. The method of producing an anti-reflection film as defined in claim 18, wherein the drying of the solvent away is performed with the heated drying air at a wind velocity of 1 m/sec or more.
